(19) United States
(12) Patent Application Publication
(10) Pub. No.: US 2025/0311008 A1
(43) Pub. Date: Oct. 2, 2025

(54) METHODS FOR SBFD-SPECIFIC PRACH MASK INDEX INDICATION

(71) Applicant: InterDigital Patent Holdings, Inc., Wilmington, DE (US)

(72) Inventors: Nazli Khan Beigi, Longueuil (CA); Jonghyun Park, Syosset, NY (US); Moon IL Lee, Melville, NY (US); Janet Stern-Berkowitz, Little Neck, NY (US); Paul Marinier, Brossard (CA); Aata EI Hamss, Laval (CA); Virgile Garcia, Antibes (FR)

(73) Assignee: InterDigital Patent Holdings, Inc., Wilmington, DE (US)

(21) Appl. No.: 18/624,018

(22) Filed: Apr. 1, 2024

(51) Int. Cl. H04W 74/0833; H04L 5/14

(52) U.S. Cl. CPC H04W 74/0833; H04L 5/14

(57) ABSTRACT

A method performed by a WTRU may include receiving a random access channel (RACH) configuration indicating a plurality of RACH occasions. The RACH occasions within respective subsets are frequency division multiplexed. The method includes receiving configuration information indicating at least one transmit power threshold and information indicating resources associated with a mode of operation, and receiving criteria for selecting a RACH occasion that defines a group of RACH occasions from at least one subset that overlap with at least one uplink subband. The method includes sending a preamble transmission using a calculated transmit power in a selected RACH occasion, wherein, on a condition the calculated transmit power exceeds the transmit power threshold, the selected RACH occasion is selected from the defined group of the plurality of RACH occasions that overlap with the at least one uplink subband.

### BACKGROUND

Third Generation Partnership Project (3GPP) technical specifications for Fifth Generation (5G) New Radio (NR) networks are likely to support duplex operation in the near future. This technology may provide a foundation for improvements to conventional time domain duplex (TDD) operation and may enable enhanced uplink (UL) coverage, improved capacity, and reduced latency. Conventional TDD operates by splitting the time domain between the uplink and downlink transmission directions. Network (e.g., base station) support for full duplex operation, or more specifically, subband non-overlapping full duplex (SBFD) within a conventional TDD band is currently being investigated.

Reducing the latency for access and connection establishment with the network is a key benefit that may be achieved through SBFD operation. In NR, the WTRU may be configured with RACH occasions (RO) in time and frequency domain. In NR-TDD, the ROs may only be valid if they coincide with UL slots in the time domain, and the WTRU may avoid physical random access channel (PRACH) preamble transmission if the ROs are in downlink (DL) slots.

### SUMMARY

A method performed by a WTRU may include receiving a random access channel (RACH) configuration indicating a plurality of RACH occasions. RACH occasions within respective subsets are frequency division multiplexed. The method includes receiving configuration information indicating at least one transmit power threshold and information indicating resources associated with a mode of operation, and receiving criteria for selecting a RACH occasion that defines a group of RACH occasions from at least one subset that overlap with at least one uplink subband. The method includes sending a preamble transmission using a calculated transmit power in a selected RACH occasion, wherein, on a condition the calculated transmit power exceeds the transmit power threshold, the selected RACH occasion is selected from the defined group of the plurality of RACH occasions that overlap with the at least one uplink subband.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example structure of SBFD resources;

FIG. 3 illustrates an example of the content of an RRC Configuration message that includes the parameter ssb-perRACH-OccasionAndCB-PreamblesPerSSB;

FIG. 4 is a diagram illustrating an example of an SSB-to-RO mapping where the number of ROs to which each SSB is mapped, N, is 4;

FIG. 5 is a table illustrating information that may be conveyed to a WTRU as part of an SBFD-specific PRACH Mask Index indication;

FIG. 6 is a flow diagram illustrating a procedure as may be performed by a WTRU for RACH occasion selection in an SBFD mode of operation;

FIG. 7A is an illustration of an SSB-to-RO mapping based upon which SBFD RO limitations relating to a number, R, of middle ROs may be applied prior to RO selection by a WTRU; and

FIG. 7B is an illustration of an SSB-to-RO mapping based upon which SBFD RO limitations relating to a number, R, of lower ROs may be applied prior to RO selection by a WTRU.

### DETAILED DESCRIPTION

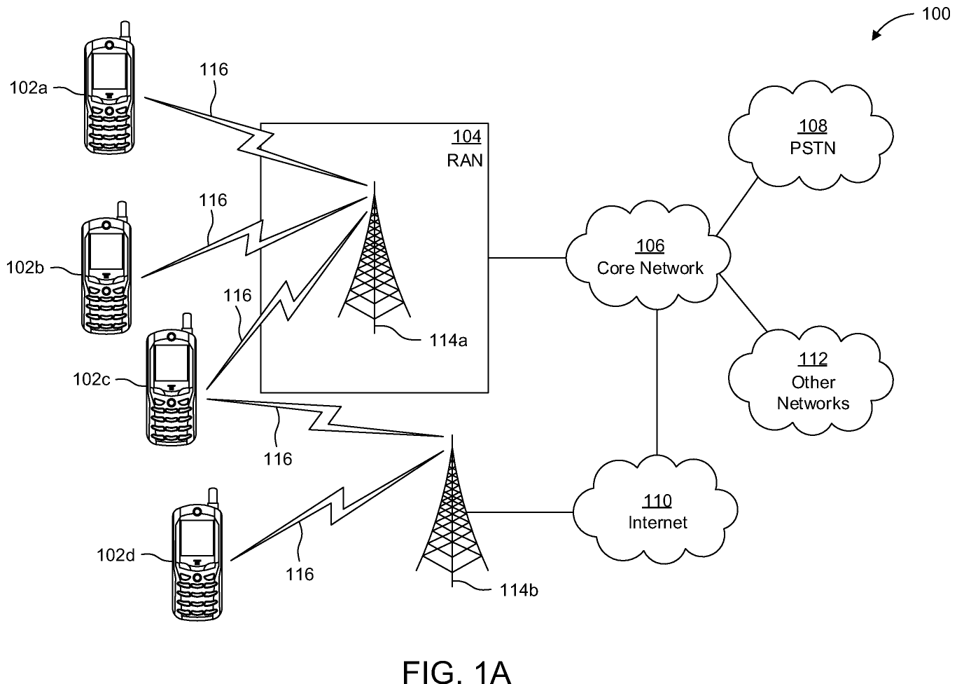

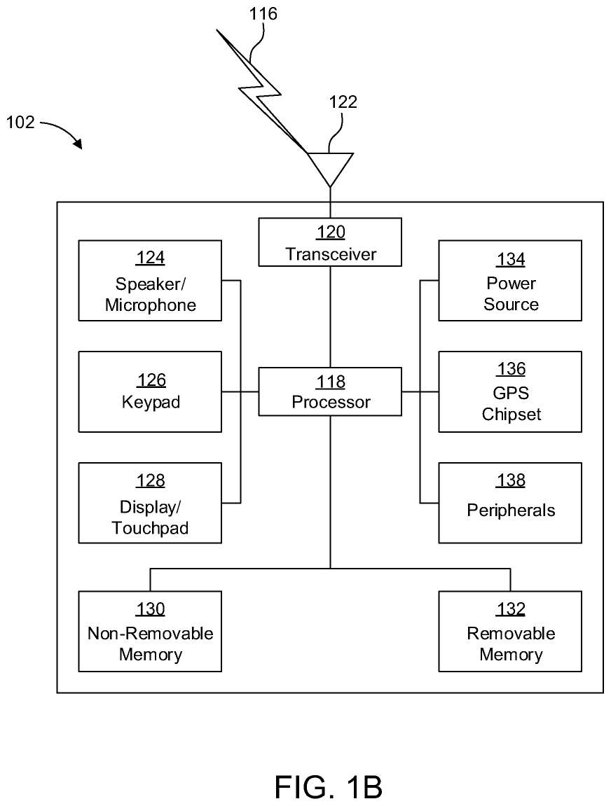

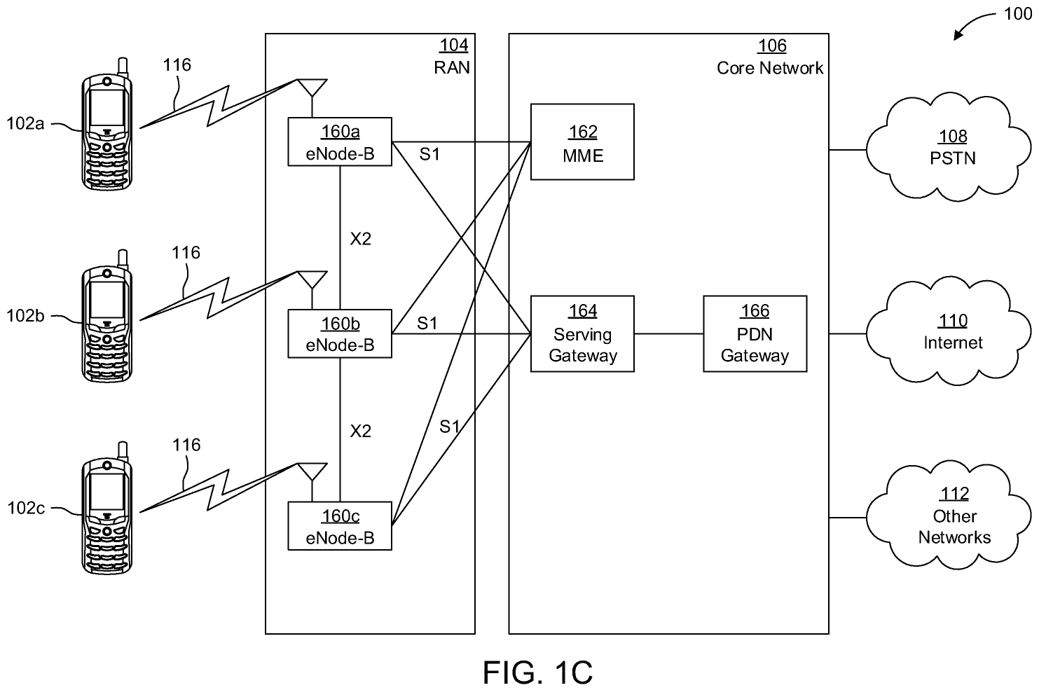

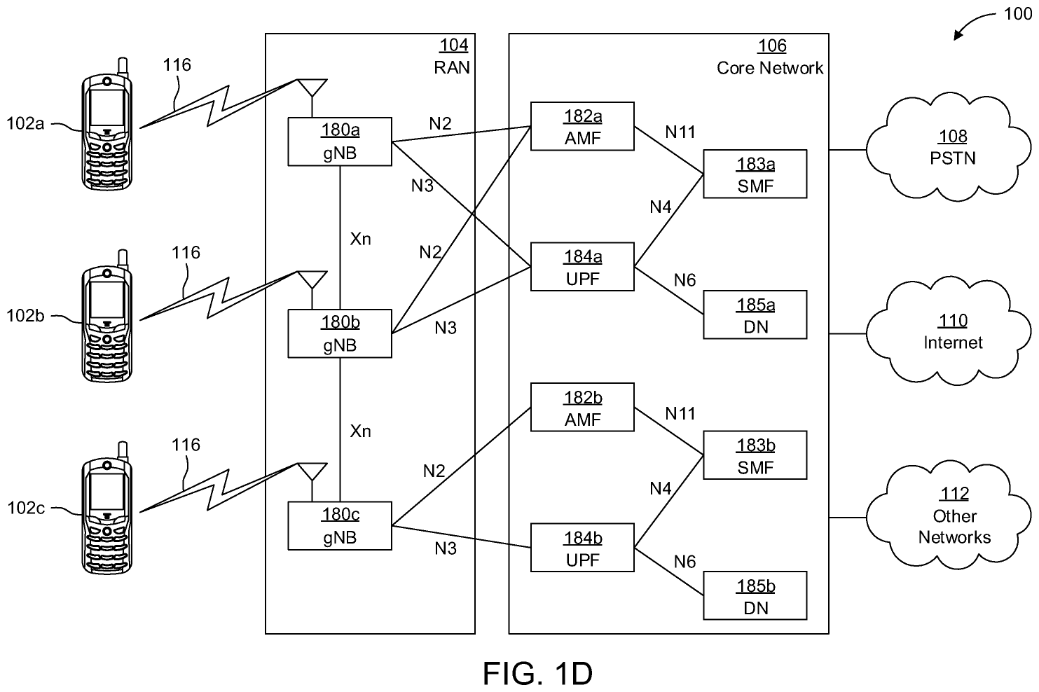

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A listing of abbreviations and acronyms as used herein is provided below:
BWP Bandwidth Part
CB Contention-Based
CLI Cross-Link Interference
CP Cyclic Prefix
CS Channel State Information
CSI-RS Channel State Information-Reference Signal
DCI Downlink Control Information
DL Downlink
DM-RS Demodulation Reference Signal
EPRE Energy Per Resource Element
FDD Frequency Division Duplexing
FDM Frequency Division Multiplexing
MAC Medium Access Control
MAC CE Medium Access Control Control Element
MIMO Multiple Input Multiple Output
MTC Machine-Type Communications
NAS Non-Access Stratum
NR New Radio
OFDM Orthogonal Frequency-Division Multiplexing
PDU Protocol Data Unit
PRACH Physical Random-Access Channel
PRB Physical Resource Block
RACH Random Access Channel
RAR Random Access Response
RB Resource Block
RE Resource Element
RO Random Access Occasion
RRC Radio Resource Control
RS Reference Signal
RSRP Reference Signal Received Power
RSRQ Reference Signal Received Quality
SBFD Subband non-overlapping full duplex
SCS Sub-Carrier Spacing
SRS Sounding Reference Signal
TCI Transmission Configuration Index
TDD Time-Division Duplexing
TDM Time-Division Multiplexing
TRP Transmission/Reception Point
UL Uplink

Cross-link interference (CLI) in the context of TDD wireless systems may refer to interference that occurs between uplink (UL) and downlink (DL) transmissions within the same TDD frame or time slot. In TDD systems, the same frequency band may be shared for both UL and DL transmissions, but the transmissions occur in different time slots or frames. This means that UL and DL transmissions may happen within the same frequency resources, but in different time intervals.

Cross-link interference may occur due to various reasons, including imperfect synchronization, imperfect channel estimation, or adjacent channel Interference in the case of closely spaced frequency channels, when there might be interference between UL and DL transmissions in neighboring channels. In TDD systems, dynamic power control may be used to adjust the transmit power based on channel conditions. If power control is not optimized, it can lead to interference issues. In addition, antenna crosstalk may also be accounted for in multi-antenna systems.

To mitigate cross-link interference in TDD for 5G, various techniques are employed such as advanced interference cancellation algorithms, adaptive beamforming, dynamic scheduling algorithms, sophisticated power control mechanisms, and advanced antenna designs. These techniques may optimize system performance and enhance spectral efficiency by reducing interference between UL and DL transmissions.

Considering the potential CLI that may be caused due to PRACH transmission in UL subbands in SBFD symbols, enhancements for RO selection are required. A question addressed herein may be how the WTRU may select from valid ROs based on potential CLI.

Common terminology used in the description of solutions herein is described below. Hereinafter, ‘a’ and ‘an’ and similar phrases are to be interpreted as ‘one or more’ and ‘at least one’. Similarly, any term that ends with the suffix ‘(s)’ may to be interpreted as ‘one or more’ or ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

A beam may correspond to a spatial domain filter or one or more spatial parameters. A beam may correspond to a transmission or receive direction (e.g., spatial direction) . . . . A WTRU may transmit or receive a physical channel or reference signal according to at least one beam, spatial domain filter, and/or one or more spatial parameters. The term “beam” may be used to refer to a spatial domain filter a spatial direction, one or more spatial parameters, and/or the like.

The WTRU may send a transmission on a physical channel or may send a signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit on a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit on the first (target) physical channel or signal according to a spatial relation with a reference to the second (reference) physical channel or signal.

A spatial relation may be implicit, configured by RRC or signaled by a MAC CE, DCI, or another logical equivalent. For example, a WTRU may implicitly send a PUSCH transmission and a DM-RS of the PUSCH according to the same spatial domain filter as an SRS indicated by an SRI indicated in DCI or configured by RRC signaling, or other logically equivalent signaling. In another example, a spatial relation may be configured by RRC for an SRS resource indicator (SRI) or signaled by MAC CE in a PUCCH transmission. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication”.

The terms TRP, MTRP, and M-TRP may be interpreted as follows. Hereafter, the term TRP (e.g., transmission and reception point) may be interchangeably used with one or more of the terms TP (transmission point), RP (reception point), RRH (radio remote head), DA (distributed antenna), BS (base station), a sector (of a BS), and a cell (e.g., a geographical cell area served by a BS), but still remain consistent with the example solutions described herein. Hereafter, the term Multi-TRP may be interchangeably used with one or more of the terms MTRP, M-TRP, or multiple TRPs, but still consistent with the example solutions described herein.

The term subband may be interpreted as follows. Hereinafter, the term “subband” and/or “sub-band” may be used to refer to a frequency-domain resource and may be characterized by at least one of the following: a set of resource blocks (RBs); a set of resource block sets (RB sets) such as those used when a carrier has intra-cell guard bands; a set of interlaced resource blocks; a bandwidth part, or portion thereof; or a carrier, or a portion thereof.

For example, a subband may be characterized by a starting RB and number of RBs for a set of contiguous RBs within a bandwidth part. A subband may also be defined by the value of a frequency-domain resource allocation field and bandwidth part index.

Hereinafter, the term “XDD” may be used to refer to a subband-wise duplex operation (e.g., either UL or DL being used per subband) and may be characterized by at least one of the following: Cross Division Duplex (e.g., subband-wise FDD within a TDD band); subband non-overlapping full duplex (SBFD); subband-based full duplex (e.g., full duplex where both UL and DL are used/mixed within a symbol/slot, but either UL or DL being used per subband on the symbol/slot); frequency-domain multiplexing (FDM) of DL/UL transmissions within a TDD spectrum; a full duplex mode other than a same-frequency (e.g., spectrum sharing, subband-wise-overlapped) full duplex mode; or an advanced duplex method, e.g., other than (pure) TDD or FDD.

The term dynamic/flexible TDD may be interpreted as follows. Hereinafter, the term “dynamic (/flexible) TDD” may be used to refer to a TDD system/cell which may dynamically (and/or flexibly) change/adjust/switch a communication direction (e.g., a downlink, an uplink, or a sidelink, etc.) at a time instance (e.g., slot, symbol, subframe, and/or the like). In some examples, in a system employing dynamic/flexible TDD, a component carrier (CC) or a bandwidth part (BWP) may have one single type among ‘D’ (e.g., DL), ‘U’ (e.g., UL), and ‘F’ (e.g., flexible) on a symbol/slot, based on an indication by a group-common (GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU communicating/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU communicating/associated with the second gNB based on a second SFI and/or tdd-UL-DL-config configured/indicated by the second gNB. In some examples, the first WTRU may determine that the reception of the downlink signal is being interfered by the uplink signal, where the interference caused by the uplink signal may refer to a WTRU-to-WTRU cross-layer interference (CLI).

Hereafter, the term downlink reception may be used interchangeably with Rx occasion, PDCCH, PDSCH, SSB reception, but still consistent with solutions described herein.

Hereafter, the term uplink transmission may be used interchangeably with Tx occasion, PUCCH, PUSCH, PRACH, SRS transmission, but still be consistent with solutions described herein.

Hereinafter, the terms time instance, slot, symbol, and subframe may all be used interchangeably, but still be consistent with solutions described herein.

Hereinafter, the terms UL-only and DL-only Tx/Rx occasions may be used interchangeably with the terms legacy TDD UL or legacy TDD DL, respectively, and still remain consistent with solutions described herein. In some examples, the legacy TDD UL transmission or legacy DL reception occasions may represent cases where SBFD is not configured and/or where SBFD is disabled.

Hereinafter, the terms received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably, but still remain consistent with solutions described herein.

Hereinafter, the term CLI may be used interchangeably with interference, and still remain consistent with solutions described herein after.

Hereinafter, the term non-SBFD may be understood to be interchangeably with the phrase ‘operation without SBFD, TDD, legacy TDD’, and still remain consistent with solutions described herein.

Hereinafter, the terms ‘paired spectrum’ and FDD may be used interchangeably, but still remain consistent with solutions described herein.

Hereinafter, the terms ‘unpaired spectrum’ and TDD may be used interchangeably, but still remain consistent with solutions described herein.

Hereinafter, the term ‘gNB’, ‘NodeB’, ‘base station’, ‘node’, ‘network node’, or TRP may be referred to interchangeably.

Hereinafter, the phrases ‘WTRU is configured’, ‘WTRU is indicated’, ‘WTRU receives configuration’, and so forth, may imply that a configuration or indication is received or indicated, for example, ‘via RRC, MAC-CE, DCI, MIB, SIB, and so forth’, unless indicated otherwise. For example, the phrase ‘WTRU is configured’ may imply the ‘WTRU is configured via RRC, MAC-CE, MIB, SIB, and so forth’.

Hereinafter, the phrase ‘preamble received target power’ may be used interchangeably with the terms PRACH power, preamble power, UL power, UL RSRP, and/or UL RSSI.

Hereinafter, the phrase ‘maximum power’ may be used interchangeably with the terms maximum output power, maximum transmit power, PCMAX, P_{CMAX,c}, P_{CMAX,f,c}, P_{CMAX}, and so forth, and still remain consistent with solutions described herein.

Hereinafter, the terms PRACH, RACH, random-access, random-access occasion, RACH occasion, PRACH transmission, PRACH transmission occasions, RACH transmission, RA, and RO, may be used interchangeably, and still remain consistent with solutions described herein. The terms RACH and RACH procedure may also be used interchangeably herein.

The solutions provided herein may be applied to RO selection for PRACH preamble transmissions in any type of random access procedures, including, for example, Type-1 random access (e.g., 4-step PRACH), Type-2 random access (e.g., 2-step PRACH), or other types of random access procedures.

Subband non-overlapping full duplex (SBFD) operation is described herein. A WTRU may be configured with one or more types of slots within a bandwidth. A first type of slot may be used or determined for a first direction (e.g., downlink); a second type of slot may be used or determined for a second direction (e.g., uplink). A third type of slot may have a first group of frequency resources within the bandwidth for a first direction and a second group of frequency resources within the bandwidth for a second direction. Hereinafter, the term ‘bandwidth’ may be interchangeably used with the terms bandwidth part (BWP), carrier, subband, or system bandwidth.

The first type of slot (e.g., the slot for a first direction) may be referred to as downlink slot. The second type of slot (e.g., slot for a second direction) may be referred to as an uplink slot. The third type of slot may be referred to as a Sub-Band (non-overlapping) Full Duplex (SBFD) slot. The group of frequency resources for a first direction may be referred to as downlink subband, downlink frequency resource, or as downlink RBs. A group of frequency resources for a second direction may be referred to as uplink subband, uplink frequency resource, or uplink RBs. A group of frequency resources for a flexible direction (e.g., that may be configured for a first direction, second direction, etc.) may be referred to as a flexible subband, flexible frequency resource, or flexible RBs. The group of frequency resources between a first direction and a second direction may be referred to as guard band, guard frequency resource, or guard RBs.

In some examples, a (SBFD-enabled) WTRU may receive or be configured with one or more SBFD UL or DL subbands in one or more DL, UL, and/or flexible TDD time instances (e.g., symbols, slots, frames, and so forth). The WTRU may be configured with one or more resource allocations for SBFD subbands.

For example, the SBFD configuration may include a flag signal (e.g., enabled/disabled), where, for example, a first value of the signal (e.g., zero (0) may indicate a first mode of operation (e.g., SBFD configuration), and a second value (e.g., one (1)) may indicate a second mode of operation (e.g., non-SBFD operation). The modes of operation (e.g., SBFD or non-SBFD) may be indicated via, for example one or more MIBs, SIBs, RRC messages, MAC-CEs, DCIs, and or other logically equivalent signaling.

The WTRU may receive an indication of time resources (e.g., one or more symbols, slots, and so forth), for which the first mode of operation (e.g., SBFD) is defined in for example one or more BWPs, subbands, component carriers (CC), cells, and so forth. The WTRU may receive the frequency resources (e.g., subbands, BWPs, etc. including one or more PRBs) within (active and/or linked) BWP, for which the first mode of operation (e.g., SBFD) is configured. The time instances (e.g., slots, symbols) may be indicated based on periodic, semi-persistent, or aperiodic configurations. In some examples, the time instances may be indicated via a bitmap configuration, in which each bit corresponds to a time instance (e.g., slot, symbol, subframe, etc.) and each bit indication may indicate whether corresponding time instance can be used for the first or second mode of operation.

In some examples, a WTRU may be configured with a DL TDD configuration for a component carrier (CC) or a BWP for one or more Rx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured as the UL channels and/or Tx occasions.

In some examples, the WTRU may be configured with an UL TDD configuration for a component carrier (CC) or a BWP for one or more Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured as the DL channels and/or Rx occasions.

In some examples, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where, for example, a first value (e.g., zero (0)) may indicate a first direction (e.g., UL duplexing mode), and a second value (e.g., one (1)) may indicate a second direction (e.g., DL duplexing model). The duplexing mode configuration and/or flag for the first mode of operation (e.g., SBFD) may be configured as part of a mode of operation configuration, for example via a MIB, SIB, RRC message, DCI, MAC-CE, or another logically equivalent message. The duplexing mode configuration and/or flag for the first mode of operation (e.g., SBFD) may be configured as part of a resource allocation configuration for a Tx/Rx occasion.

In some examples, a WTRU may be configured with one or more types of slots. The WTRU may be configured with a first slot with a first type, where the first type may be, for example, a SBFD slot. The WTRU may be configured with a second slot with a second type, where the second type may be, for example, a non-SBFD slot. As for the first slot with the first type (SBFD), the WTRU may be configured with two or more subbands (e.g., DL, UL, flexible, guard, or other types of subbands) in the frequency domain, throughout the BWP, for the duration of the first slot. However, in the second slot with the second type (non-SBFD), the WTRU may be configured with only one direction type, for example (e.g., DL, UL, flexible, or other type), in the frequency domain, throughout the BWP, for the duration of the second slot.

In some examples, if the WTRU is configured with a second slot with an UL direction, it may be implicit that the second slot is a legacy TDD UL slot, a UL-only slot, and/or non-SBFD UL slot. In some examples, if the WTRU is configured with a third slot with a second type (non-SBFD) in the DL direction, it may be implicit that this slot is a legacy TDD DL slot, DL-only slot, and/or non-SBFD DL slot. In some examples, if the WTRU is configured with a fourth slot with a second type (non-SBFD) with flexible direction, it may be implicit that this slot is a legacy TDD flexible slot and/or non-SBFD flexible slot, and so forth.

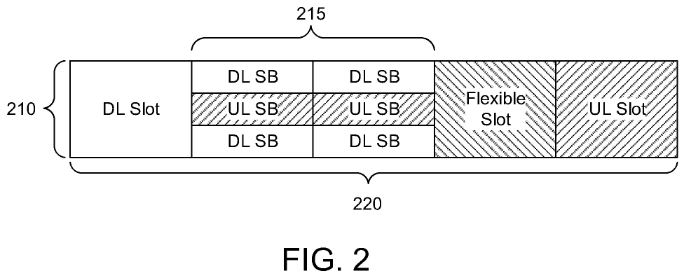

FIG. 2 is a diagram illustrating an example structure of SBFD resources. In the example shown in FIG. 2, a TDD cycle may be defined within a time duration 220 that extends over five slots and are allocated within a bandwidth 210. The SBFD resources as shown are defined within two slots 215 that encompasses three subbands. The example configuration shown in FIG. 2 is a downlink-uplink-downlink (DUD) configuration, reflecting the presence of two DL subbands with a single UL subband between them. The SBFD slots are preceded by a DL slot and are followed respectively by a flexible slot and an UL slot.

RACH Configurations are described in further detail herein. A WTRU may receive, identify, or be configured with time domain resource allocations for one or more (e.g., consecutive) RACH Occasions (RO) based on one or more higher-layer parameters, if configured. These parameters may include, for example, prach-ConfigurationIndex, or msgA-PRACH-ConfigurationIndex. These parameters may denote a PRACH configuration index corresponding to one or more tables that include random access parameters.

The WTRU may be configured with one or more parameters for RACH. For example, the WTRU may be configured with a preamble format. For example, the WTRU may be configured with a preamble format that may refer to one of the possible formats, namely: A1, A2, A3, B1, A1/B1, A2/B2, A3/B3, B4, C0, C2. The preamble format may identify or be associated with a corresponding Cyclic Prefix (CP) duration, sequence part duration, guard time duration (if applicable), etc.

The WTRU may be configured with a frame number, subframe number, and/or slot number. For example, the WTRU may be configured with time-domain allocations, subframe number, and/or slot numbers during which the ROs may be configured. Using this parameter, the WTRU may determine the RO slot, for example within the corresponding subframe, where the WTRU may transmit the configured PRACH in one or more of the determined ROs.

The WTRU may be configured with a starting symbol. For example, the WTRU may determine the symbol-level index corresponding to the starting position of the first RO transmission within the indicated and/or determined RO slot.

The WTRU may be configured with a number of PRACH slots within a reference slot (e.g., a slot with a 60 KHz SCS). For example, the WTRU may receive an indication of a number of PRACH slots within a reference slot (e.g., a slot with a 60 KHz SCS). In some examples, the WTRU may be configured with the number of PRACH slots for high SCS values such as 120 kHz, 480 kHz, 960 kHz, etc., where the WTRU may consider the 60 KHz PRACH slot the reference slot.

The WTRU may be configured with a number of time-domain PRACH occasions within a PRACH slot (Nₜ^{RA,slot}). For example, the WTRU may be configured with the number of consecutive ROs that are located within a PRACH slot in the time domain.

The WTRU may be configured with a PRACH duration. For example, the WTRU may be configured with the duration of an RO in number of symbols, or another time domain resource length.

A WTRU may receive the frequency domain resource allocations for the ROs based on one or more higher-layer parameters. The one or more higher-layer parameters may include msg1-FrequencyStart or msgA-RO-FrequencyStart, if configured, which may indicate an offset of (or from) the lowest PRACH transmission occasion in frequency domain with respect to the PRB 0. The one or more higher-layer parameters may include the parameters msg1-FDM or msgA-RO-FDM, if configured, which may indicate the number of PRACH transmission occasions that are FDMed in one time-domain RO.

The WTRU may receive, identify, or be configured with a number of ROs in frequency domain (M) per each time-domain PRACH occasion based on the higher layer parameters msg1-FDM, msg1-FDM-16, or msgA-RO-FDM, if configured, where msg1-FDM={one, two, four, eight}.

The WTRU may number the PRACH frequency resources nRA={0,1, . . . , M−1}, starting from the lowest frequency, in increasing order in the initial uplink BWP during the initial access or the active uplink BWP otherwise.

A WTRU may receive an indication of an association and mapping between the SS/PBCH block indexes and PRACH transmission occasions based on higher layer parameter ssb-perRACH-OccasionAndCB-PreamblesPerSSB={⅛, ¼, ½, 1, 2, 4, 8, 16}. The parameter indicates the number of SS/PBCH block indexes associated with a PRACH transmission occasion in addition to the number of preambles per SS/PBCH block index per PRACH occasion.

Further details regarding RACH configurations are provided herein. A WTRU may determine, be configured, and/or indicated to receive and/or detect one or more SSBs. The WTRU may determine to perform random access procedure based on at least one of the detected and/or received SSBs. For example, the WTRU may send PRACH transmissions, Msg 1, Msg 3, or other transmissions, or receive RAR and/or further signaling as part of the random access procedure. In some examples, the WTRU may receive and/or detect SSBs and perform a random access (RA) procedure as part of initial access procedures, beam failure recovery procedures, among other types of procedures. In some examples, the WTRU may initiate a random access procedure based on at least one received PDDCH order, in which where the WTRU may receive configuration information and/or indications regarding SSBs, PRACH preambles, RACH resources, or other aspects or parameters related to RACH configurations.

Msg 1, as introduced in paragraphs above, may include a PRACH preamble transmission. Msg 3, as introduced in paragraphs above, may include a PUSCH transmission that may be transmitted based on an UL grant received in a RAR that the WTRU receives in response to the Msg 1 transmission.

The WTRU may receive configuration information and/or indications for performing the random access procedure. For example, the WTRU may receive the configuration information and indications via SIB, RRC, MAC-CE, DCI, and so forth. For example, the configuration information and/or indications may correspond to the transmission of Msg 1 or Msg A, if configured. In an example, the configuration information may include one or more parameters, which could include the following described parameters. The parameters included in the configuration information may include a PRACH configuration index. For example, the WTRU may receive a PRACH configuration index that may indicate an available set of PRACH occasions for the transmission of PRACH preamble for Msg 1 or Msg A, if configured. In some examples, a WTRU may be configured, indicated, and/or determine to use the configured and/or indicated PRACH configuration index based on one or more duplex configurations. In some examples, the WTRU may be configured to use the configured PRACH configuration index via an indication in, or linked to an entry in, a first table, where the first table may, for example, be used by WTRUs operating in an FDD operation mode. The WTRU may be configured to use a configured PRACH configuration index via an indication to a second table, where the second table may, for example, be used for WTRUs operating in a TDD operation mode. The WTRU may be configured to use the configured PRACH configuration index via an indication to a third table, where the third table may for example be used for WTRUs operating in SBFD operation, and so forth.

Msg A may include a preamble transmission and (e.g., combined with or followed by) a PUSCH transmission.

The parameters included in the configuration information may include a preamble received target power. For example, the WTRU may receive information indicating an initial random access preamble power for the transmission of Msg 1 and/or Msg A.

The parameters included in the configuration information may include an RSRP threshold for repetition number (e.g., X) of Msg1 or MsgA. For example, the WTRU may receive configuration information related to an RSRP threshold, based on which the WTRU may determine to transmit the PRACH preamble repetition X number of times. In some examples, if the WTRU determines that a measured DL pathloss RSRP is lower than the received threshold for repetition number X, the WTRU may transmit the PRACH repetition X times.

The parameters included in the configuration information may include a power ramping step (e.g., powerRampingStep, msgA-PreamblePowerRampingStep, powerRampingStepHighPriority). For example, the WTRU may be configured to carry out a power ramping step by increasing the PRACH transmission power, up to a configured maximum number of times (e.g., preambleTransMax), or until a RAR is received.

The parameters included in the configuration information may include a maximum number of preamble transmissions (e.g., preambleTransMax, preambleTransMax-Msg1-Repetition, msgA-TransMax, etc.): For example, the WTRU may be configured with a maximum number of Random Access Preamble transmissions (e.g., Y), based upon which the WTRU may increase the UL transmission power at each PRACH transmission occasion through a power ramping step (e.g., taking into account the parameters defined by powerRampingStep). In some examples, a WTRU that is configured with a repetition number X, may perform PRACH repetition for X times, where the WTRU may transmit each repetition up to Y times that is the configured maximum number of allowed preamble transmission times (e.g., preambleTransMax-Msg1-Repetition). The WTRU may stop preamble transmissions if a RAR is received. In cases where the RAR is not received, and maximum number of preamble transmission is reached, the WTRU may switch to repetition with the next available higher repetition number.

RACH Occasion Types are described herein. In some examples, a WTRU may be configured with one or more RACH occasion (RO) types. For example, the WTRU may be configured with a Type 1 RO, where the Type 1 ROs coincide with one or more TDD UL-only time instances. In some examples, the WTRU may be configured with a Type 2 RO, where the Type 2 ROs coincide with one or more SBFD time instances. The WTRU may be configured to perform PRACH transmission(s) based on one or more of the configured RO types. In some examples, the random access resources corresponding to different RO types may be mutually exclusive.

RACH repetition configurations are described in further detail herein. In some examples, a WTRU may receive one or more configurations and/or indications on random access repetition. For example, the WTRU may receive the configuration and/or indication via a SIB, RRC message, MAC-CE, DCI, or other logically equivalent signaling. In some examples, the WTRU may determine the number of repetitions (e.g., X) based on one or more measured signal quality parameters and one or more thresholds. For example, the WTRU may measure a DL pathloss RSRP and determine that the measured RSRP is lower than a configured threshold. The configured threshold may be associated with a particular number of repetitions, X, and as such, the WTRU may be configured to transmit preamble repetitions for the determined X times. The WTRU may determine the number of random access resources based on the determined number of repetitions (e.g., X)., The WTRU may determine the resources based on an association between the determined, selected, and/or configured SSB and the configured ROs. In some examples, the WTRU may determine whether the selected BWP for the random access procedure is configured with the set(s) of random access resources corresponding to the number of RO repetitions, e.g., X, if the measured RSRP of the downlink pathloss reference is less than a configured threshold, e.g., given by rsrp-threshold-repetitionNumX, that is associated with the number of RO repetitions.

In some examples, the WTRU may determine the random access resources separately for different RO Types. For example, the WTRU may determine a set of random access resources corresponding to the configured and/or determined repetition times on Type 1 ROs; the WTRU may determine the set of random access resources corresponding to the configured and/or determined repetition times on Type 2 ROs, and so forth.

PRACH power calculations are described herein. PRACH power (e.g., for a PRACH preamble transmission) may be determined by a WTRU. The WTRU may determine the PRACH power based on one or more of a preamble received target power (e.g., which may be referred to as PREAMBLE_RECEIVED_TARGET_POWER) that may be determined by the WTRU and a determined, measured, or calculated pathloss. The WTRU may limit the power based on a maximum power (e.g., Pcmax,c which may also be represented by Pcmax,f,c.).

For example, a WTRU may determine a transmission power for a physical random access channel (PRACH), P_{PRACH,b,f,c}(i), on active UL BWP b of carrier f of cell c based on DL RS for cell c in transmission occasion i as shown in Equation 1 below:

$${P}_{PRACH , b , f , c} ( i ) = min \{ {P}_{CMAX , f , c} ( i ) , {P}_{PRACH , target , f , c} + {PL}_{b , f c} \} [ dBm ] \qquad Eq . 1$$

where P_{CMAX,f,c}(i) may be a WTRU-configured maximum output power for carrier f of cell c within transmission occasion i, P_{PRACH,target,f,c} may be the PRACH target reception power (e.g., given by PREAMBLE_RECEIVED_TARGET_POWER) for the active UL BWP b of carrier f of cell c, and PL_{b,f,c} may be a pathloss for the active UL BWP b of carrier f based on the DL RS associated with the PRACH transmission on the active DL BWP of cell c and may be calculated by the WTRU in dB as referenceSignalPower minus the higher layer filtered RSRP in dBm. The DL RS may be an SSB or a CSI-RS.

The WTRU may determine PREAMBLE_RECEIVED_TARGET_POWER based on a power ramping counter and a power ramping step. For example, PREAMBLE_RECEIVED_TARGET_POWER may be determined as preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA. One or more of preambleReceivedTargetPower, DELTA_PREAMBLE, PREAMBLE_POWER_RAMPING_STEP, and POWER_OFFSET_2STEP_RA may be configured (e.g., received via signaling such as a SIB or RRC message, or another logically equilvalent message). POWER_OFFSET_2STEP_RA may be omitted or set to 0, for example when a 4-step RA procedure is used.

The WTRU may determine a maximum power (e.g., maximum output or maximum transmit power) it may use for a transmission based on one or more of the following: a maximum power associated with the WTRU's power class, power reductions allowed for meeting requirements such as emissions or SAR (Specific Absorption Rate) requirements, reductions related to tolerances, and/or a signaled maximum power, e.g., Pemax,c.

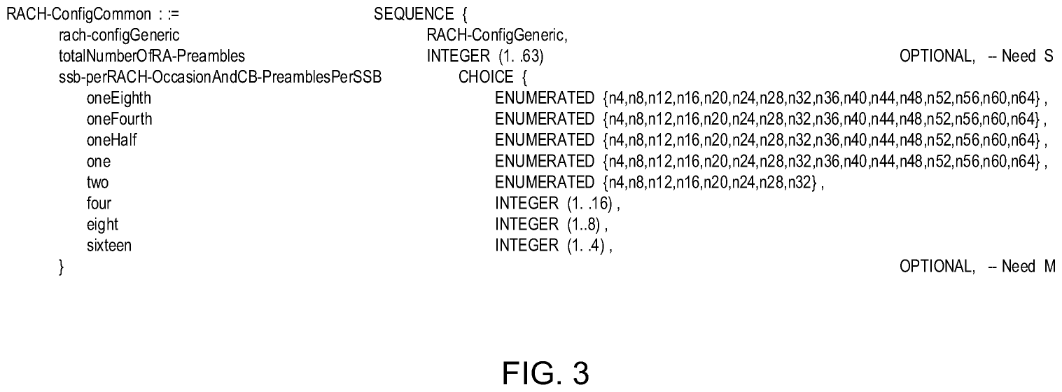

SSB to RO mappings are described in further detail herein. In a random access procedure, a WTRU may be provided with a number of SSB indexes associated with one RACH occasion by ssb-perRACH-OccasionAndCB-PreamblesPerSSB, within an SSB-RO mapping cycle, as illustrated in FIG. 3, introduced and described in further detail below. The number of SSB indexes associated with one RACH occasion, as defined by ssb-perRACH-OccasionAndCB-PreamblesPerSSB, may be less than one, as indicated by a fractional value (e.g., ⅛, ¼, ½), which indicates that each SSB index is associated with multiple RACH occasions (e.g., one SSB is associated with eight, four, or two, in the respective examples provided). The number of SSB indexes associated with one RACH occasion, as defined by ssb-perRACH-OccasionAndCB-PreamblesPerSSB, may be equal to or greater than one, as indicated by an integer value (e.g., 1, 2, 4, 8, 16). In these cases, there may be a one-to-one relationship between SSB indices and RACH occasions, or each RACH occasion may be associated with multiple SSBs.

FIG. 3 illustrates an example of the content of an RRC Configuration message that includes the parameter ssb-perRACH-OccasionAndCB-PreamblesPerSSB. The RACH-ConfigCommon element, as shown in FIG. 3, is one element that may carry the ssb-perRACH-OccasionAndCB-PreamblesPerSSB. The CHOICE portion of the element indicates the number of SSB indices associated with each RACH occasion (or, alternatively, the number of RACH occasions associated with each SSB index). The ENUMERATED portion indicates the number of contention based preambles associated with each SSB index. The possible number of contention based preambles is expressed for each corresponding number of SSB indicates associated with each RACH occasion.

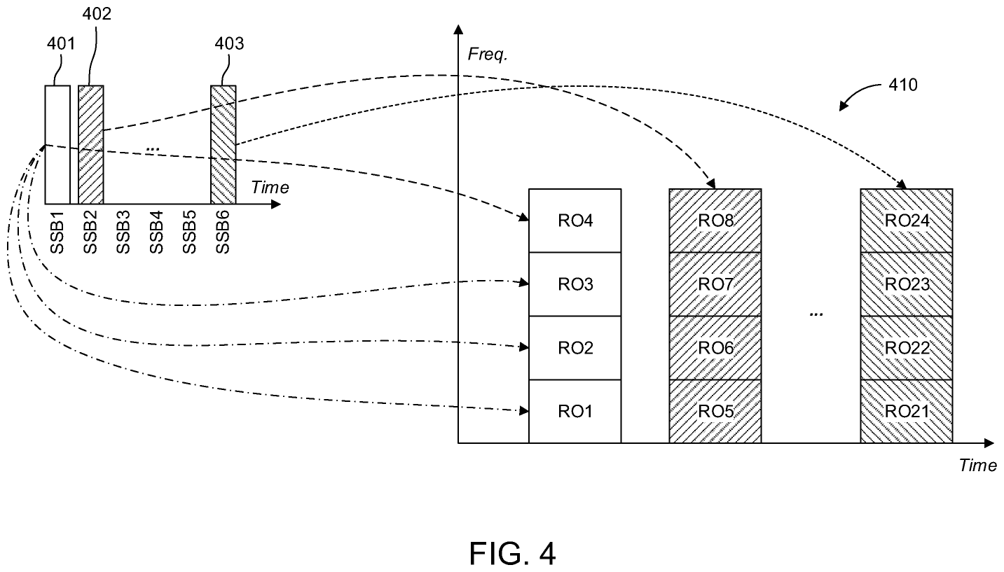

FIG. 4 is a diagram illustrating an example of an SSB-to-RO mapping where the number of ROs to which each SSB is mapped (e.g., N is 4). As shown in FIG. 4, an RO configuration is shown for each of three SSBs, 401, 402, and 403. The example FIG. 4 shows M=4 consecutive ROs are configured to be FDM-ed in each RO time instance, that may be configured via Msg1-FDM. Each SSB 401, 402, and 403 has a corresponding SSB index, and each SSB index may mapped to N=4 configured consecutive ROs, as provided by the parameter ssb-perRACH-OccasionAndCB-PreamblesPerSSB, (e.g., where the value of ssb-perRACH-OccasionAndCB-PreamblesPerSSB=¼). For example, the total number of SSBs shown is 6 (though the SSB-to-RO mapping for SSB3, SSB4, and SSB5 is not shown). The number of ROs to which each SSB is mapped is given by the parameter N=4. Accordingly, as shown in graphic 410, SSB1 is mapped to RO1-RO4, SSB2 is mapped to RO5-RO8, and SSB6 is mapped to RO21-RO24. Once the WTRU performs selection of an appropriate SSB to use for its PRACH preamble transmission, The WTRU may select one RO (e.g., randomly) out of the N configured ROs for the selected SSB to transmit the PRACH preamble, unless the WTRU has received PRACH Mask Index indication, indicating further limitations on the allowed ROs per SSB, as is described in further detail in paragraphs below.

Methods for transmitting PRACH preambles based on PRACH Mask Index indications are described herein. In some examples, a WTRU may be configured with an SSB-to-RO mapping, where each SSB is mapped to N consecutive ROs. The WTRU may receive a Mask-Index indication to indicate the allowed PRACH occasion(s).

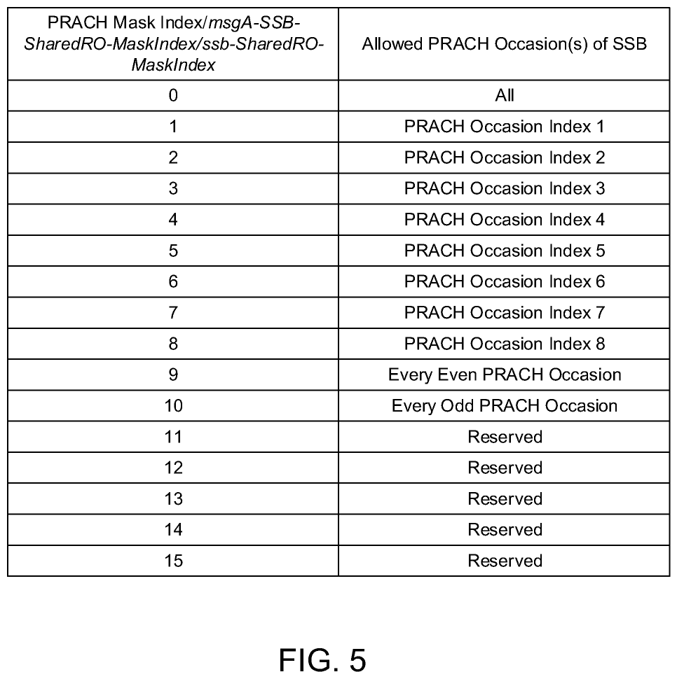

FIG. 5 is a table illustrating information that may be conveyed to (or configured in) a WTRU as part of PRACH Mask Index indication. As shown, a PRACH Mask Index may correspond to one or more allowed RACH occasions, from which a WTRU may select for transmission of a PRACH preamble. The PRACH Mask Index may be specified as a limitation on the selection of RACH occasions for a selected SSB. Thus, the allowed PRACH occasions provided by one or more PRACH Mask Index values may serve to reduce the subset of possible RACH occasions configured for a particular selected SSB. A PRACH Mask Index may refer to a single RACH occasion, or may refer to multiple RACH occasions (e.g., every even-numbered RACH occasions or every odd-numbered RACH occasion).

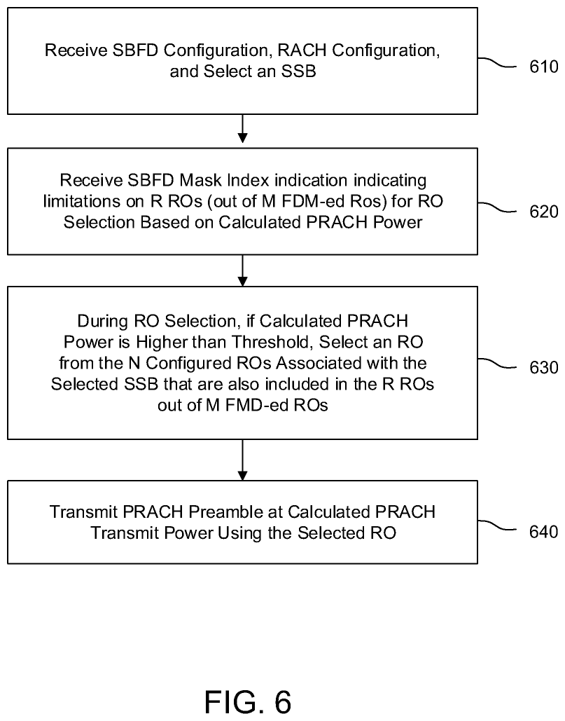

FIG. 6 is a flow diagram illustrating a procedure as may be performed by a WTRU for RACH occasion selection in an SBFD mode of operation. In the context of FIG. 6, at 610, the WTRU detects one or more SSBs and, for example, decodes a corresponding SIB1, e.g., during initial access. The WTRU receives an SBFD configuration (e.g., via a SIB), which indicates time and frequency resources associated with an SBFD mode of operation. For example, one or more slots may be configured with at least one UL subband and at least one DL subband. The SBFD configuration may specify resources that have a DUD configuration (2 DL subbands with an UL subband between them) as shown in FIG. 2, for example.

The WTRU also receives a RACH configuration (e.g., via SIB1), where the configuration indicates that each of one or more SSBs is mapped to N ROs (e.g., consecutive ROs) and where M ROs (e.g., consecutive ROs) are FDM-ed in frequency domain. The WTRU performs measurements of the detected one or more SSBs (e.g., by receiving and/or measuring a reference signal received power associated with the one or more of the SSBs), which may then be used to select one of the SSBs.

At 620, the WTRU receives an indication (e.g., via SIB1) that indicates a limitation (also referred to herein as “criteria”) for RO usage in SBFD time resources (e.g., slots). The limitation may define a group of RACH occasions that are within or overlap with the SBFD resources from which a WTRU may select an RO. The limitation may be indicated by an SBFD mask (e.g., via SBFD Mask Index indication, e.g., ssb-SBFD-MaskIndex), and one or more thresholds associated with a calculated PRACH transmit power.

The SBFD RO limitation (e.g., SBFD Mask Index indication) may define a group of R ROs or indicate a subset of R ROs (e.g., consecutive ROs) out of the M FDM-ed ROs. In some examples, the limitation may indicate the R middle ROs of the M ROs may be indicated such that R may be two, four, or six ROs, though it should be appreciated that the specific number of ROs may take other values. The R ROs may be in the UL subband in the SBFD configuration.

The RROs may be in the middle of the UL subband (e.g., for DUD configuration) or may include ROs at an edge of the UL subband (e.g., for DU or UD configuration), where the edge may be the edge farthest from the DL subband.

At 630, the WTRU, having selected an SSB that is associated with the M FDM-ed ROs, may select one of the N configured ROs for transmission of the PRACH preamble. When selecting an RO in an SBFD time resource (e.g., slot), the WTRU uses the received SBFD RO limitation to select an RO based on the configured N ROs per SSB, M FDM-ed ROs, indicated R ROs, and a calculated PRACH power that is based on channel conditions that may vary, for example, based on possible cross-link interference.

If, as in the example shown in FIG. 6, the WTRU is configured with an SBFD limitation of R ROs (e.g., R middle ROs) and the PRACH power calculated by the WTRU is higher than the configured threshold, the WTRU selects an RO from the N ROs corresponding to the selected SSB that are also included in the indicated RROs (e.g., R middle ROs). In the case the calculated PRACH power is lower than the threshold, the WTRU may select an RO from the N ROs corresponding to the selected SSB (e.g., without considering the SBFD RO limitation).

As shown at 640, the WTRU transmits a PRACH preamble using the selected RO.

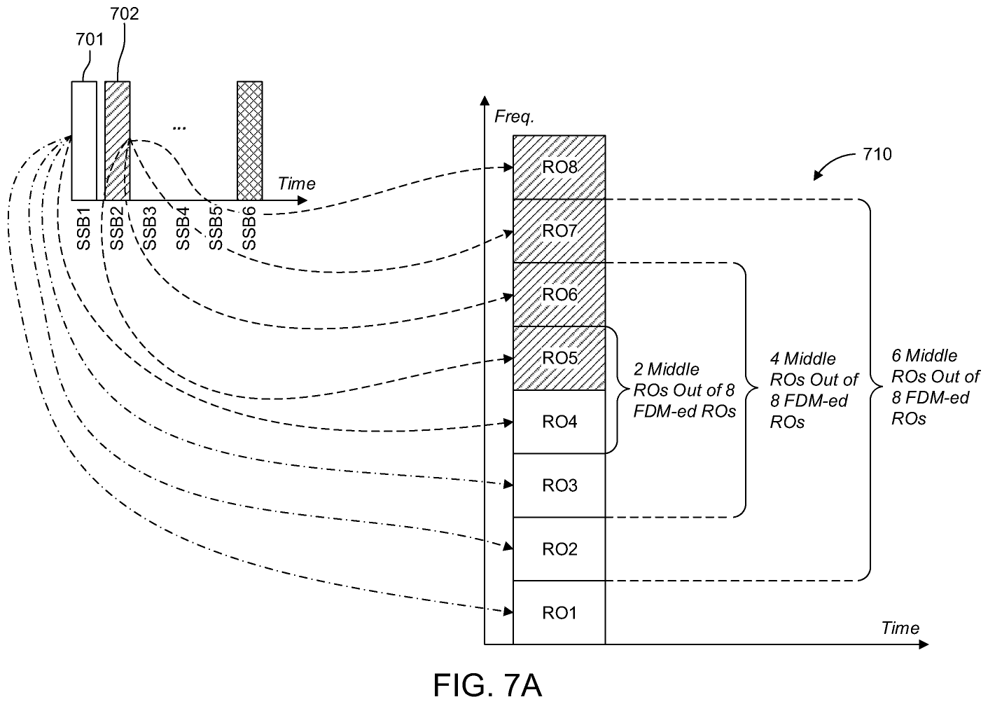

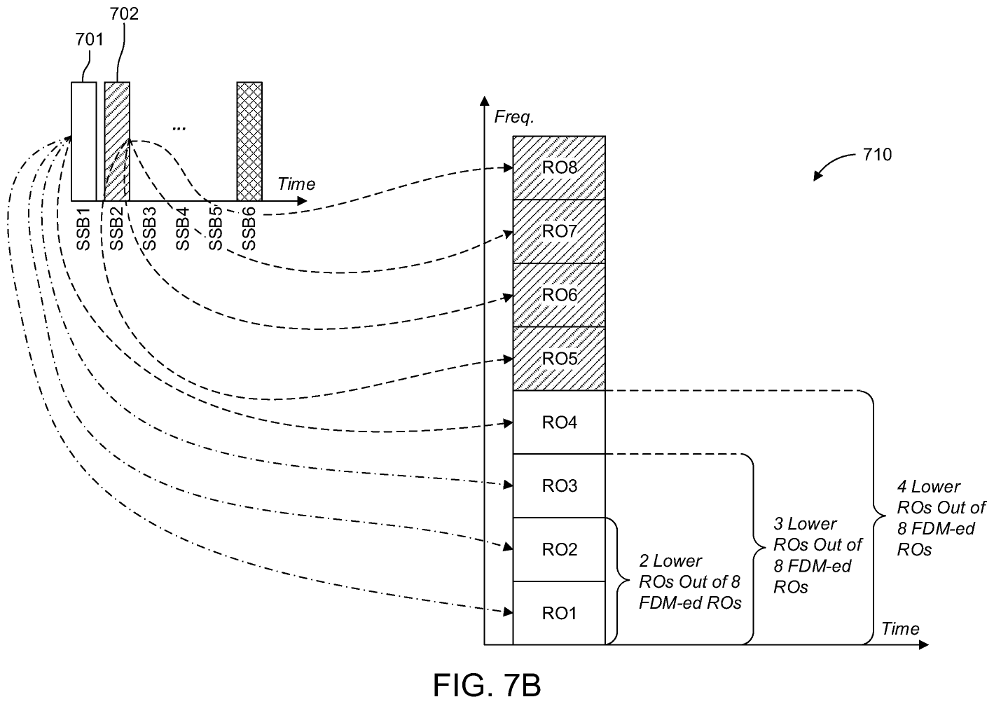

In some examples, the WTRU may receive multiple transmit power thresholds, which may be associated with multiple different PRACH Mask Indexes. The network (e.g., a base station or another network node or entity) may transmit configuration information including the multiple different thresholds and/or corresponding PRACH Mask information to the WTRU. The WTRU may evaluate each of the different PRACH transmit power thresholds and apply an appropriate PRACH mask. Examples of solutions that may involve multiple thresholds are described further below in the contexts of FIGS. 7A-7B.

Further solutions involving the indication of a SBFD-specific PRACH mask are described herein. A WTRU may receive, detect, measure, and/or select an SSB, which may include receiving, detecting and/or measuring one or more reference signals associated with one or more SSBs. For example, the WTRU may measure the received power (e.g., RSRP) based on the received SSBs and select an SSB based on the measured received power (e.g., with highest RSRP). The WTRU may use the selected SSB for connecting to a cell and/or for PRACH preamble transmission to the cell. The WTRU may receive a physical broadcast channel (PBCH). The PBCH may carry system information. The PBCH may include or carry a master information block (MIB). The term MIB may be used to represent the content, information, payload, and/or bits carried by the PBCH. PBCH and MIB may be used interchangeably herein. The PBCH may be part of an SS/PBCH block (SSB). The SSB may have, include, or be associated with an SSB index. A reference signal corresponding to the SSB may include a sequence generated based on the index of the SSB. A gNB or cell may transmit one or more SSBs where each SSB may have an SSB index.

In some examples, the WTRU may use configuration information received via or as part of a PBCH, MIB, and/or SSB to determine the resources to monitor, receive and/or detect a Control Resource Set Zero (CORESETO) for receiving Type0-PDCCH Common Search Space (CSS). The Type0-PDCCH CSS may include indications to one or more System Information Blocks (SIB), for example SIB1. In another example, the WTRU may be configured, indicated, or receive configuration information, for example via RRC, MAC-CE, DCI, etc., for receiving SIBs.

Further aspects relating to RACH Occasion configurations are provided herein. The WTRU may receive configuration information associated with, indicating, or defining Random Access Occasions (ROs), and the configuration information may include information on time and frequency resources where the ROs are configured and/or scheduled. For example, the WTRU may receive the configuration information via SIB, RRC, MAC-CE, DCI, etc. For example, the WTRU may receive the configuration information as part of a SIB during initial access. In some examples, the WTRU may receive the configuration information via RRC messaging in the context of a BFR procedure. In some examples, the WTRU may receive the configuration information via a MAC-CE as part of PDCCH order, or via other logically equivalent signaling.

In some examples, the WTRU may receive configuration information regarding the number of ROs that are mapped in the frequency domain for the configured RO time instances. That is, the WTRU may receive configuration information on the number of ROs that are FDM-ed in one time instance (e.g., via msg1-FDM). For example, the WTRU may be configured with M ROs that may be FDM-ed in the frequency domain per configured RO time instance. The M Ros that are FDM-ed in the frequency domain may be, for example, consecutive or non-consecutive ROs.

In some examples, the ROs configuration information may include the number of ROs that each SSB is mapped to. That is, the WTRU may be configured to use one out of a configured number (for example, N) of consecutive ROs for sending a PRACH transmission associated with an SSB. In other words, the WTRU that has received, detected, and/or selected an SSB with an indicated SSB index, may be configured to use one of the configured NROs for PRACH preamble transmission, that are mapped and/or associated with the selected SSB.

FIG. 7A illustrates an example of an SSB-to-RO mapping where M=8 ROs are FDM-ed in an RO time instance, and each of the SSBs 701 and 702 are mapped to N=4 ROs. That is, in an example consistent with FIG. 7A, the WTRU that may be configured, indicated, or may have selected SSB1 701 (e.g., as the “best” SSB or the SSB having a highest measured signal strength or a measured signal strength that exceeds a threshold value), based on which to perform random access, may transmit a PRACH preamble on one RO out of N=4 configured ROs, e.g., as shown in the RO1, RO2, RO3, or RO4. In another example, the WTRU that may have selected or may be configured and/or indicated to perform random access based on SSB2 702, may transmit PRACH preamble on one out of N=4 configured ROs, e.g., RO5, RO6, RO7, or RO8.

The SBFD configuration is described in greater detail herein. A WTRU may receive configuration information providing SBFD time and frequency resources. For example, the WTRU may receive the SBFD configuration information, for example via a SIB, RRC messages, MAC-CE, DCI, or other logically equivalent signaling. In some examples, the WTRU may receive an indication of the time resources (e.g., symbols, slots, frames, etc.) where the SBFD configuration may be applied. In some examples, WTRU may receive an indication of the frequency resources (e.g., CC, BWP, subband, RBs, etc.) where the SBFD configuration may be applied. For example, the WTRU may be configured with at least one UL subband, one DL subband, guard bands, etc. with regards to a SBFD configuration.

In some examples, the WTRU may be configured with DUD configuration, in which an UL subband is configured between two DL subbands. In another example, the WTRU may be configured with UD configuration, where an UL subband is configured with higher frequencies followed by a DL subband with lower frequencies. In another example, the WTRU may be configured with DU configuration, where a DL subband is configured with higher frequencies followed by au UL subband with lower frequencies. These examples are non-limiting examples of the SBFD configurations and parameters that may be included in SBFD configurations. One or more of those configurations may be included. Other configurations may be included.

The SBFD Mask Index indication is further described herein. In some solutions, a WTRU may receive or be configured with configuration information and/or indications of one or more limitations, rules, and/or criteria associated with or for selecting one or more ROs. For example, the WTRU may receive the configuration information and/or indications via a SIB, RRC messaging, MAC-CE, DCI, or other logically equivalent signaling. For example, the WTRU may receive the indications as part of a SIB during initial access. In some examples, the WTRU may receive the configuration information or indications via RRC messaging, such as in the course of a BFR procedure. In some examples, the WTRU may receive the configuration information or indications via a MAC-CE as part of a PDCCH order. In some examples, the WTRU may receive configuration information or an indication of a limitation on RO usage, such as for the ROs that are configured in SBFD resources (e.g., UL subband, e.g., in SBFD symbols, slots, frames, etc.). In some examples, the indication may be provided via a SBFD Mask Index indication (e.g., ssb-SBFD-MaskIndex). The WTRU may also receive and/or be configured with one or more threshold values for PRACH transmit power corresponding to the configured RO limitations.

In some solutions, the indication of the SBFD RO limitation (e.g., SBFD Mask Index indication) may indicate a subset of ROs based upon which the WTRU may consider applying limitations in the selection of an RO for PRACH preamble transmission. In some examples, the SBFD RO limitation indication may indicate a subset of R ROs out of M configured FDM-ed ROs. In some examples, the indicated R ROs may be consecutive ROs out of M FDM-ed ROs. In other examples, the indicated R ROs may be non-consecutive ROs out of M FDM-ed ROs.

In some examples, for an SBFD system with DUD configurations, the indication may indicate R middle ROs of the M configured FDM-ed ROs, such as in the UL subband of an SBFD time instance. For example, the R may be two, four, or six middle ROs.

FIGS. 7A-7B are illustrations of SSB-to-RO mappings each with multiple different SBFD RO limitations applied.

Further describing FIG. 7A, an SSB-to-RO mapping with M=8 FDM-ed ROs in frequency domain may be configured, where each SSB 701 and 702 may be mapped to four ROs. For example, SSB 701 may be mapped to RO1-RO4 and SSB 702 may be mapped to R05-RO8. The WTRU may receive an SBFD Mask Index indication, which may indicate an SBFD RO limitation. In the example of FIG. 7A, the SBFD RO limitation indication may indicate the R=2 middle ROs out of M=8 FDM-ed ROs (e.g., RO4 and R05); the SBFD RO limitation indication may indicate the R=4 middle ROs out of M=8 FDM-ed ROs (e.g., RO3-RO6), and/or the SBFD RO limitation indication may indicate the R=6 middle ROs out of M=8 FDM-ed ROs (e.g., RO2-RO7), and so forth, as can be seen. During RO selection, the WTRU may be restricted to selecting an RO that lies both within the ROs mapped to the selected SSB and within the indicated R ROs.

In another example as shown in FIG. 7B, for an SBFD system with DU configurations, the indication may indicate R lower ROs of the M configured FDM-ed ROs, for example in the UL subband of an SBFD time instance. SSB 701 may be mapped to RO1-RO4 and SSB 702 may be mapped to R05-RO8, as shown in the inset illustration 710. For example, the number R may be two, four, six, etc. lower ROs. In some examples, given an SSB-to-RO mapping with M=8 FDM-ed ROs in the frequency domain, the SBFD RO limitation indication may indicate the R=2 lowest ROs out of M=8 FDM-ed ROs; the SBFD RO limitation indication may indicate R=4 lowest ROs out of M=8 FDM-ed ROs; the SBFD RO limitation indication may indicate R=6 lowest ROs out of M=8 FDM-ed ROs, and so forth. In this example, the “lowest” ROs may imply the configured ROs with lower frequency compared with other configured ROs in the same RO time instance. In other words, in this example, the “lowest” ROs may imply the configured ROs that are closer to the DL subband edge compared to the other configured ROs.

In another example, such as one involving an SBFD system with UD configurations, the indication may indicate R higher ROs of the M configured FDM-ed ROs, for example in the UL subband of an SBFD time instance. For example, the number R may be two, four, six, etc. higher ROs. In some examples, given an SSB-to-RO mapping with M=8 FDM-ed ROs in frequency domain, the SBFD RO limitation indication may indicate R=2 highest ROs out of M=8 FDM-ed ROs; the SBFD RO limitation indication may indicate R=4 highest ROs out of M=8 FDM-ed ROs; the SBFD RO limitation indication may indicate R=6 highest ROs out of M=8 FDM-ed ROs, and so forth. In this example, the “highest” ROs may implicitly refer to configured ROs with higher frequencies compared with other configured ROs in the same RO time instance. In other words, in this example, the “highest” ROs may imply the configured ROs that are closer to the DL subband edge compared to the other configured ROs in the same RO time instance.

In other examples not shown, the group of available ROs may be indicated on other bases. The network (e.g., a base station or another network node or entity) may be configured to determine the SBFD Mask Index or Indices based on activity of other device operating within the cell. For instance, the network may determine the SBFD Mask in a manner that minimizes cross-link interference.

In the examples illustrated in FIGS. 7A-7B, the network (e.g., a base station or another network node or entity) may provide multiple SBFD RO limitation indications to the WTRU along with, or for evaluation based on different PRACH transmit power thresholds. For instance, in the example of FIG. 7A, The WTRU may receive three PRACH transmit power thresholds each associated with SBFD RO limitations for the cases where R=4 middle ROs, R=6 middle ROs, and R=8 middle ROs. In some cases, the lower transmit power threshold may be associated with a least restrictive SBFD RO limitation (e.g., where R=6 middle ROs in the example of 7A). A next higher transmit power threshold may be associated with a next least restrictive SBFD RO limitation (e.g., where R=4 middle ROs in the example of 7A). A highest transmit power threshold may be associated with a most restrictive SBFD RO limitation (e.g., where R=2 middle ROs in the example of 7A). This arrangement may help to diminish cross-link interference with transmissions occurring in neighboring bands while offering greater resource availability for PRACH preamble transmission. It should be well understood that other arrangements may be possible in which other limited groups of ROs are chosen by the network in association with different PRACH transmit power thresholds and signaled to the WTRU.

Modes of operation that may be used based on configured SBFD Mask Index indication are described herein. In some solutions, a WTRU may use a received, configured, and/or indicated SBFD RO limitation indication to select an RO for PRACH preamble transmission in an SBFD time resource. For example, the SBFD time resource may be an SBFD symbol, slot, frame, or another time resource. In some examples, the WTRU may select the RO for PRACH preamble transmission in an SBFD time instance from the N configured ROs, based on a limitation that may be imposed on using the RROs out of M configured FDM-ed ROs, configured and/or indicated via SBFD RO limitation. In some examples, the WTRU may select an RO from the N configured ROs corresponding to the selected SSB that may be also included in the indicated R ROs. In some examples, the WTRU may avoid sending a PRACH preamble transmission in configured ROs (out of N configured ROs) other than the received, configured, and/or indicated RROs. That is, the WTRU may consider the configured ROs other than the configured R ROs to be invalid for PRACH preamble transmission.

In some solutions, the WTRU may apply a received, configured, and/or indicated SBFD RO limitation when selecting an RO in an SBFD time instance in combination with one or more conditions. In some examples, the conditions may be based on PRACH power, selected SSB's measured power (e.g., RSRP), etc.

In some examples, the WTRU may determine or be configured with selecting the mode of operation with regards to the received, configured, and/or indicated SBFD RO limitation indication, based on one or more conditions. For example, the modes of operation may be to limit or to not limit selecting the ROs in SBFD time instances for PRACH preamble transmission to the ROs (out of N configured ROs) that are also in the received, indicated, and/or configured R ROs. In an example, one or more of the following modes of operation may apply.

A first mode of operation may entail applying limitations on the ROs. For example, in the first mode of operation, the WTRU may limit the RO selection only to the ROs that are indicated and/or configured via the SBFD RO limitation indication (e.g., R ROs).

In some examples, the WTRU may determine the mode of operation based on a calculated PRACH power and at least a corresponding configured threshold value. As such, the WTRU may determine and/or be configured to limit the RO selection to the indicated and/or configured R subset of ROs, in case the measured and/or calculated PRACH power is higher than the corresponding threshold.

In some examples, the WTRU may determine the mode of operation based on the received power of an SSB (e.g., RSRP) and one or more corresponding configured threshold values. As such, the WTRU may determine and/or be configured to limit the RO selection to the indicated and/or configured R subset of ROs, in case the measured SSB's received power is lower than the corresponding threshold, which may, for example, result in the WTRU calculating a higher PRACH transmit power.

A second mode of operation may entail not limiting the ROs. For example, in the second mode of operation, the WTRU may not limit the RO selection to the ROs that are indicated and/or configured via SBFD RO limitation indication (e.g., R ROs) and the WTRU may select from all N available ROs.

In some examples, the WTRU may determine the mode of operation based on a calculated PRACH power and one or more corresponding configured threshold values. As such, the WTRU may determine and/or be configured to not limit the RO selection to the indicated and/or configured R subset of ROs, in case the measured and/or calculated PRACH power is lower than the corresponding threshold.

In some examples, the WTRU may determine the mode of operation based on received power of an SSB (e.g., RSRP) and one or more corresponding configured threshold values. As such, the WTRU may determine and/or be configured to limit the RO selection to the indicated and/or configured R subset of ROs, in case the measured SSB's received power is higher than the corresponding threshold (i.e., resulting in lower PRACH power).

A third mode of operation may entail fallback to non-SBFD ROs. For example, based on the configured available ROs, the M configured FDM-ed ROs, the R indicated ROs with limitations, and one or more conditions, the WTRU may determine that there are no valid ROs associated with the selected SSB. In other words, there may be no valid ROs available for a PRACH preamble transmission. In some examples, the WTRU may determine that all configured ROs that are associated with WTRU's selected SSB are invalid based on the configured available ROs, the M configured FDM-ed ROs, the R indicated ROs with limitations, and one or more conditions. As such, the WTRU may determine to not use the RO that is in the SBFD time instances. The WTRU may determine to use an RO that is associated with the selected SSB, and is configured in the non-SBFD time instances (e.g., Type 1 ROs, UL-only symbols, slots, frames, etc.). One or more of the following scenarios described in the following paragraphs may apply.

ROs may be unavailable due to one or more specific configurations. In an example, based on the M configured FDM-ed ROs and R configured ROs with limitations, in addition to one or more of the conditions (if configured), the WTRU may determine that the WTRU may be restricted to using only the configured R ROs. In case the WTRU determines that none of the N configured ROs overlap with the R configured ROs, the WTRU may determine that the WTRU may not be able to transmit a PRACH preamble on any of the N configured ROs. In other words, the WTRU may determine that none of the N configured ROs are valid for PRACH preamble transmission. As such, the WTRU may determine to fallback to using non-SBFD ROs to PRACH preamble transmission.

ROs may be unavailable due to SSB Mask Index indication. In some examples, the WTRU may receive one or more indications and/or configuration information that may allow the WTRU to use a subset of K configured ROs for the selected SSB out of N configured ROs. The indications or configuration information may be provided, for example, via a SSB Mask Index indication. Moreover, based on the M configured FDM-ed ROs and R configured ROs with limitations, in addition to one or more of the conditions (if configured), the WTRU may determine that the WTRU may be limited to only use the configured RROs. In case the WTRU determines that none of the K configured and/or allowed ROs overlap with the R configured ROs, the WTRU may determine that the WTRU is not be allowed to transmit a PRACH preamble on any of the K configured ROs. In other words, the WTRU may determine that none of the K configured ROs are valid for PRACH preamble transmissions. As such, the WTRU may determine to fallback to using non-SBFD ROs to perform the PRACH preamble transmission.

In some examples, based on the selected RO (e.g., valid RO), the WTRU may transmit the PRACH preamble.

RO selection enhancements based on distance with edges in SBFD systems are described herein. An SBFD-capable WTRU may be configured with an SSB-to-RO mapping with N<1. The WTRU may receive an SBFD-Mask-Index in addition to thresholds to indicate the allowed PRACH occasion(s) associated with an SSB based on the calculated PRACH transmit power. A WTRU may perform one or more of the following steps.

The WTRU may detect an SSB and decodes a corresponding SIB1 during initial access or during a BFR procedure, based on which the WTRU performs random access. The WTRU may receive a RACH configuration (e.g., via SIB1), where the configuration indicates that each of one or more SSBs is mapped to N ROs (e.g., consecutive ROs) and where M ROs (e.g., consecutive ROs) are FDM-ed in frequency domain. The WTRU may receive an indication or configuration information (e.g., via SIB1), that includes thresholds based on a distance between an RO and the nearest DL subband edge, e.g., based on a threshold number of RBs.

The indication or configuration information may also include an association between ROs and random access types. The WTRU may use the received indication or configuration information to select the ROs based on one or more thresholds and the calculated PRACH power.

If the distance between the selected RO and the edge band is lower than the threshold number of RBs and if the PRACH power is lower than corresponding threshold, the WTRU may use the RO.

The WTRU may use the received indication or configuration to select the RO type. The WTRU may use R inner ROs for a 2-step RACH procedure and outer ROs for a 4-step RACH procedure (with regards to measured received RSRP and corresponding thresholds). The WTRU may select one RO and transmit a PRACH preamble in the selected RO based on the allowed RACH occasions for the selected SSB.

RO selection based on a distance between an RO and a DL subband edge is described herein. In some solutions, the WTRU may determine to select an RO based on a distance (e.g., frequency-domain distance, RB-level distance, and/or RE-level distance) between the RO and a reference frequency resource (e.g., reference RB or RE that may be nearest to the RO) of a non-UL region, e.g., DL resource, DL subband in an SBFD (or FD) system, guardband in an SBFD (or FD) system, subband edge region in an SBFD (or FD) system, a DL channel or signal, etc. In some examples, the reference frequency resource may be an RB (or RE) that is closest to the RO (e.g., the nearest DL subband).

Selection of the RO based on the distance may include selecting the RO based on a determination that the distance is larger than a threshold. The threshold may be (pre-) configured or indicated to the WTRU. In some examples, the WTRU may receive the configuration via a SIB, RRC message, MAC-CE, DCI, or other logically equivalent signaling. For example, the WTRU may receive the indications as part of a SIB during initial access. In some examples, the WTRU may receive the indications via RRC message in the context of a BFR procedure. In some examples, the WTRU may receive the indications via one or more MAC-CEs as part of PDCCH order.

Selecting the RO based on the distance may comprise selecting the RO based on determining that the distance is larger than a first threshold and/or a determined PRACH power is lower than a second threshold, where the second threshold may be varying (e.g., may be determined as a different value) depending on the distance. For example, a value of the second threshold may be determined to be a higher value as the distance (e.g., between the RO and the nearest DL subband or guardband) goes higher, e.g., farther away from the nearest DL subband or guardband edge which may result in a lowered CLI effect, so that relatively higher PRACH transmission power being determined may be allowed if the selected RO is farther away enough from the nearest DL subband or guardband edge.

Selecting the RO based on the distance may include selecting the RO based on a determination that the distance is larger than a first threshold and/or a determined PRACH power is lower than a second threshold and/or based on a configured or indicated random access type (e.g., either a 2-step RACH procedure, or a 4-step RACH procedure, etc.). For example, if a 2-step RACH procedure is configured or used, the WTRU may select an RO that may be located in the middle part of candidate or valid ROs in a given time instance, where the selected RO may be one or more of 2, 4, and/or 6 inner ROs in frequency. This may be because a relatively higher PRACH power may be required for robust PRACH transmission for the 2-step RACH procedure, which may result in higher CLI. If a 4-step RACH procedure is configured or used, the WTRU may select an RO that may have a location other than the middle part of candidate or valid ROs in a given time instance, where the selected RO may be one or more of outer ROs in frequency, e.g., because a relatively lower PRACH power may be required for the 4-step RACH procedure, which may result in lowered CLI effect.

In some examples, if the distance between the selected RO and the non-UL region (e.g., DL subband, guardband, subband edge region) is larger than the first threshold, the WTRU may determine to use the RO and may transmit a PRACH preamble using the selected RO.

In some examples, if the distance between the selected RO and the non-UL region (e.g., DL subband, guardband, subband edge region) is lower than the first threshold and the determined PRACH power is lower than the second threshold, the WTRU may determine to use the RO and may transmit a PRACH preamble based on the selected RO and the determined PRACH power.

An operational example of WTRU in RRC-Idle and/or Inactive mode is provided herein. A WTRU in RRC-Idle and/or Inactive mode may receive configuration information and/or threshold(s) relating to rules for selecting the ROs to be used, e.g., via broadcast signal(s), e.g., SIB, SIB1, SIB #k, etc. and/or subsequent control command(s). The configuration information may include an indication whether a cell is operating in a full duplex (FD) mode of operations (e.g., conducting SBFD operation, or operating as an SBFD system), where the cell may be a cell transmitting (e.g., broadcasting) the SIB1 or a second cell indicated by or associated with a cell-ID (e.g., Physical cell-ID; PCI). The configurations may include threshold(s) related to PRACH transmit power per candidate frequency position of RO(s), such as for middle RO(s), edge RO(s), an n-th RO(s), a set of ROs with a starting RO index n, or other groups of ROs, within a subband, (e.g., an UL subband). The configurations may include threshold(s) associated with a distance between an RO and the nearest DL subband edge (e.g., expressed based on number of RBs). The configurations may comprise information on time and frequency resources where the candidate ROs are located, such as on symbol(s) and/or slot(s).

The WTRU may determine a number of ROs that are mapped in the frequency domain for a configured RO time instance. The WTRU may determine the number of ROs (e.g., valid ROs) that are FDM-ed in one time instance (e.g., based on the configurations (such as those indicating a parameter such as msg1-FDM). The WTRU may determine M consecutive ROs (e.g., valid ROs) that are FDM-ed in frequency domain for the configured RO time instance. The WTRU may determine a set of ROs, e.g., N ROs (e.g., of the M ROs) that an SSB (e.g., with a corresponding SSB index) is mapped to, where the SSB may be an SSB that the WTRU may detect and selected for performing initial access for a cell associated with (e.g., transmitting) the SSB.

In some examples, the WTRU may select a first RO among the N ROs upon determining that a distance between the first RO and a reference frequency resource (e.g., a reference RB or RE that may be nearest to the RO) of a non-UL region (e.g., a DL subband or guardband in an SBFD (or FD) system) is larger than a first threshold. The threshold may be (pre-) configured or indicated to the WTRU. Based on the selection of the first RO, the WTRU may transmit a PRACH preamble using the first RO having determined a PRACH transmission power based on a PRACH power control mechanism and/or a PRACH power ramping process.

In some examples, the WTRU may select a second RO among the NROs upon determining that a distance between the second RO and a reference frequency resource (e.g., a reference RB or RE that may be nearest to the RO) of a non-UL region (e.g., a DL subband or guardband in an SBFD (or FD) system) is larger than a first threshold and a determined PRACH power is lower than a second threshold. It may mean that a selection of the first RO may result in a determined PRACH power based on selecting the first RO being higher than the second threshold, thus the WTRU may select the second RO (instead of the first RO) that satisfies the condition that the determined PRACH power is lower than the second threshold. It may mean that the first RO is located closer toward the nearest DL subband or guardband edge, compared with the case for the second RO. Based on selecting the second RO, the WTRU may transmit a PRACH preamble using the second RO and based on the determined PRACH power.

An operational example of a WTRU in RRC-Connected mode is provided herein. A WTRU in RRC-Connected mode may receive configuration information and/or threshold(s) on rules for selecting the ROs to be used, e.g., via broadcast signal(s), e.g., SIB, SIB1, SIB #k, and/or subsequent control command(s) such as RRC, MAC-CE, DCI or other logically equivalent messages. The configuration information may include an indication whether a cell is operating a full duplex (FD) mode of operations (e.g., SBFD operation, SBFD system), where the cell may be a cell transmitting (e.g., broadcasting) the SIB1 or a second cell indicated by a cell-ID (e.g., Physical cell-ID; PCI). The configuration information may include threshold(s) relating to a PRACH power defined for different frequency positions of RO(s). For example, different PRACH power thresholds may be associated with e.g., middle RO(s), edge RO(s), n-th RO(s), sets ROs with a given starting RO index n, etc., within a subband (e.g., UL subband). The configuration information may include threshold(s) relating to a distance between an RO and the nearest DL subband edge, which may be expressed based on a number of RBs. The configurations may include information on time and frequency resources where the candidate ROs are located, such as in symbols and/or slots.

The WTRU may determine the number of ROs that are mapped in the frequency domain for a configured RO time instance. The WTRU may determine the number of ROs (e.g., valid ROs) that are FDM-ed in one time instance (e.g., based on the configurations e.g. indicating a parameter of msg1-FDM). The WTRU may determine M consecutive ROs (e.g., valid ROs) that are FDM-ed in frequency domain for the configured RO time instance. The WTRU may determine a set of ROs, e.g., NROs (e.g., of the MROs) that an SSB (e.g., with a corresponding SSB index) is mapped to, where the SSB with the corresponding SSB index may be indicated to the WTRU via an explicit signaling, e.g., RRC signaling, MAC-CEs, DCI or other logically equivalent signaling. For example, the DCI may be a PDCCH-order DCI, where the DCI may include the corresponding SSB index indication and/or an SBFD Mask Index indication (e.g., ssb-SBFD-MaskIndex).

In some examples, the WTRU may select a first RO among the N ROs upon determining that a distance between the first RO and a reference frequency resource (e.g., reference RB or RE that may be nearest to the RO) of a non-UL region, e.g., DL subband or guardband in an SBFD (or FD) system, etc., is larger than a first threshold, where the threshold may be (pre-) configured or indicated to the WTRU. Upon selecting the first RO, the WTRU may transmit a PRACH preamble using the first RO (e.g., with a PRACH transmission power being determined, e.g., based on a PRACH power control mechanism and/or a PRACH power ramping process). The first RO may be selected based on a configured or indicated first random access type (e.g., 2-step RACH procedure). If a second random access type (e.g., 4-step RACH procedure) is configured or indicated, the WTRU may select a third RO which may be closer toward the nearest DL subband or guardband edge, compared with the case for the first RO.

In some examples, the WTRU may select a second RO among the N ROs based on determining that a distance between the second RO and a reference frequency resource (e.g., reference RB or RE that may be nearest to the RO) of a non-UL region, e.g., DL subband or guardband in an SBFD (or FD) system, etc., is larger than a first threshold and a determined PRACH power is lower than a second threshold. It may mean that a selection of the first RO may result in a determined PRACH power based on selecting the first RO being higher than the second threshold, thus the WTRU may select the second RO (instead of the first RO) that satisfies the condition that the determined PRACH power is lower than the second threshold. It may mean that the first RO is located closer toward the nearest DL subband or guardband edge, compared with the case for the second RO. Based on selecting the second RO, the WTRU may transmit a PRACH preamble using the second RO and based on the determined PRACH power. The second RO may be selected based on a configured or indicated second random access type (e.g., 4-step RACH procedure). If a first random access type (e.g., 2-step RACH procedure) is configured or indicated, the WTRU may select a fourth RO which may be farther away from the nearest DL subband or guardband edge, compared with the case for the second RO, e.g., because relatively higher PRACH power may be required for robust PRACH transmission for the 2-step RACH procedure, which may result in higher CLI effect.

Random access power ramping enhancements in SBFD systems are described herein. In some solutions, an SBFD-capable WTRU may be configured with FDM-ed ROs and first and second sets of power ramping configurations. The WTRU may receive an indication to use the first set only for inner the R ROs. The WTRU may carry out one or more steps defined in the following paragraphs.

The WTRU may detect an SSB and decode a corresponding SIB1 during initial access or BFR, based on which the WTRU performs random access. The WTRU may receive a RACH configuration (e.g., via SIB1), where the configuration indicates that M ROs (e.g., consecutive ROs) are FDM-ed in the frequency domain.

The WTRU may receive (e.g., via SIB1) a first and a second sets of power ramping configuration, where each set may include parameters such as power ramping step, TransMax, or others. The first power ramping step and the first value of TransMax may be higher than the second power ramping step and the second value of TransMax.

WTRU may receive one or more indications (e.g., via SIB1) of allowed ROs and their association with the configured first or second sets of power ramping configurations (e.g., via ssb-SBFD-PR-MaskIndex). An SBFD Power-Ramping Mask Index indication may indicate the ROs, for which the WTRU may use the first or the second sets of power ramping configurations. The WTRU may use the received indication to select the power ramping configurations based on the indicated SBFD Power-Ramping Mask Index.

In some examples, if the WTRU is configured with a first value for ssb-SBFD-PR-MaskIndex (e.g., value 11 in the table shown in FIG. 5) the WTRU may use the first set of power ramping configurations only for a first number of middle ROs (e.g., two middle ROs). The WTRU may use the second set of power ramping configurations for the outer ROs.

In some examples, if the WTRU is configured with a second value for ssb-SBFD-PR-MaskIndex (e.g., value 12) the WTRU may use the first set of power ramping configurations only for a second number of middle ROs (e.g., four middle ROs). The WTRU may use the second set of power ramping configurations for the outer ROs.

In some examples, if the WTRU is configured with a third value for ssb-SBFD-PR-MaskIndex (e.g., value 13) the WTRU may use the first set of power ramping configurations only for a third number of middle ROs (e.g., six middle ROs). The WTRU may use the second set of power ramping configurations for the outer ROs.

The WTRU may select the power ramping configurations based on the selected RO for sending the PRACH transmission. The WTRU may use the allowed set of power ramping configurations based on the selected RO and may transmit the PRACH preamble based on the selected RO.

Further detailed solutions are described herein. A WTRU may receive, detect, measure, and/or select an SSB. For example, the WTRU may measure the received power (e.g., RSRP) based on the received SSBs and select an SSB based on a measured received power (e.g., select an SSB having a highest RSRP). The WTRU may use the selected SSB for connecting to a cell, performing random access operation, and/or for PRACH preamble transmission to the cell.

The WTRU may receive configuration information relating to Random Access Occasions (ROs), and the configuration information may include one or more indications of time and frequency resources where the ROs are configured. For example, the WTRU may receive the configuration information via a SIB, RRC messages, MAC-CE, DCI, or other logically equivalent signaling. For example, the WTRU may receive indications of the RO configuration as part of a SIB during initial access. In some examples, the WTRU may receive the indications via RRC messages in the context of a BFR procedure. In some examples, the WTRU may receive the indications via MAC-CE as part of a PDCCH order.

In some examples, the WTRU may receive indications of the number of ROs that are mapped in the frequency domain for the configured RO time instances. That is, the WTRU may receive configuration information indicating the number of ROs that are FDM-ed in one time instance (e.g., via msg1-FDM). In some examples, the WTRU may be configured with M consecutive ROs that may be FDM-ed in frequency domain per configured RO time instance.

In some examples, the ROs configuration information may include the number of ROs that each SSB is mapped to. That is, the WTRU may be configured to use one out of a configured number, for example N, of configured consecutive ROs for sending a PRACH transmission associated with each SSB. In other words, the WTRU that has received, detected, and/or selected an SSB with an indicated SSB index, may be configured to use one of the configured N ROs for PRACH preamble transmission, that are mapped and/or associated with the selected SSB.

The use of different sets of power ramping configurations is described herein. In a solution, a WTRU may receive, be configured, and/or be indicated with first and a second sets of configurations for PRACH preamble transmission. The WTRU may receive an indication of or configuration information specifying an association of the configured first and second sets with one or more configured ROs (e.g., via RO indexes). For example, the WTRU may receive the sets of configurations via SIB, RRC messaging, MAC-CE, DCI, or other logically equivalent signaling. For example, the WTRU may receive the indications as part of a SIB during initial access. In some examples, the WTRU may receive the indications via RRC messages in the context of a BFR procedure. In some examples, the WTRU may receive the indications via one or more MAC-CEs as part of a PDCCH order.

In some examples, the WTRU may receive a first set and a second set of power ramping configurations, where each set may include at least configuration information for power ramping step and a maximum number of Random-Access Preamble transmissions (e.g., via the parameters preambleTransMax, preambleTransMax-Msg1-Repetition, msgA-TransMax, etc.). In some examples, the first configured power ramping step may be higher than the second configured power ramping step. In some examples, the first configured maximum number of Random-Access Preamble transmissions may be higher than the second configured maximum number of Random-Access Preamble transmissions. For example, the WTRU may increase the power ramping counter until the counter reaches the configured maximum number of Random-Access Preamble transmissions.

In some examples, the WTRU may receive the first and second sets of power ramping configurations via explicit indications of the parameters' values. In some examples, the WTRU may receive the first set of power ramping configurations based on an explicit indication of the parameters' values in addition to one or more delta and/or offset values. As such, the WTRU may determine the parameters in the second set of power ramping configurations based on the configured first set and the configured offset and/or delta values.

Associations between configured power ramping configurations and configured ROs are described herein. In some solutions, a WTRU may receive, be configured with, and/or receive an indication of (e.g., via SBFD Power-Ramping Mask Index) associations between configured sets of power ramping configurations and the configured ROs out of the configured (M) FDM-ed ROs. For example, the WTRU may receive configuration information and/or indications via SIBs, RRC messages, MAC-CE, DCI, or other logically equivalent signaling. For example, the WTRU may receive the indications as part of SIBs during initial access. In some examples, the WTRU may receive the indications via RRC messages in the context of BFR procedures. In some examples, the WTRU may receive the indications via one or more MAC-CEs as part of a PDCCH order. In some examples, the association may be with the ROs that are configured in SBFD resources (e.g., UL subband, e.g., in SBFD symbols, slots, frames, etc.).

In some examples, the WTRU may be configured to and/or indicated to use the configured and/or indicated first set of power ramping configurations in a first subset of ROs (e.g., PROs) out of the configured FDM-ed (M) ROs. In some examples, the WTRU may be configured and/or indicated to use the configured and/or indicated second set of power ramping configurations in a second subset of configured ROs (e.g., M-P remaining ROs) out of the configured FDM-ed (M) ROs.

In some examples, in an SBFD system utilizing DUD configurations, the WTRU may receive an indication to use the configured first set of power ramping configurations in Pinner ROs of the M configured FDM-ed ROs, for example in the UL subband of an RO that is in an SBFD time instance. As such, the WTRU may determine that one or more of the configured (N) ROs are within the configured subset of (P) ROs, for which the WTRU may use the configured first set of power ramping configurations. That is, the WTRU may use the configured second set of power ramping configurations in case the selected RO (i.e., selected out of the configured N ROs) is within the remaining (e.g., M-P outer) ROs out of the configured FDM-ed (M) ROs. For example, the P ROs may be two, four, or six inner ROs. In some examples, in case of M=8, if the indication indicates P=2, this may imply that WTRU may use the configured first set of power ramping configurations only in the two inner and/or middle configured ROs (out of the configured M FDM-ed ROs), and that the WTRU may use the configured second set of power ramping configurations only in the remaining six outer ROs (out of the configured M FDM-ed ROs).

In some examples, for an SBFD system with DU configurations, the WTRU may receive an indication to use the configured first set of power ramping configurations only if the selected RO (out of the configured N ROs) is within the configured subset of (P) lower ROs, out of the M configured FDM-ed ROs, for example in the UL subband of an RO that is in an SBFD time instance. That is, the WTRU may use the configured second set of power ramping configurations only if the selected RO (out of the configured N ROs) is within the remaining (M-P) ROs, out of the M configured FDM-ed ROs. For example, the configured P ROs may be two, four, six, etc. lower ROs. In this example, the “lower” ROs may imply the configured ROs with lower frequency compared with other configured ROs in the same RO time instance. In other words, in this example, the “lower” ROs may imply the configured ROs that are farthest to the DL subband edge compared to the other configured ROs.

In some examples, for an SBFD system with UD configurations, the WTRU may receive an indication that it may use the configured first set of power ramping configurations only if the selected RO (out of the configured N ROs) is within the configured subset of (P) higher ROs, out of the M configured FDM-ed ROs, for example in the UL subband of an RO that is in an SBFD time instance. That is, the WTRU may use the configured second set of power ramping configurations if the selected RO (out of the configured N ROs) is only within the remaining (M-P) ROs, out of the M configured FDM-ed ROs. For example, the configured P ROs may be two, four, six, etc. higher ROs. In this example, the “higher” ROs may imply the configured ROs with higher frequency compared with other configured ROs in the same RO time instance. In other words, in this example, the “higher” ROs may imply the configured ROs that are farthest to the DL subband edge compared to the other configured ROs.

The examples on SBFD configuration such as DUD, UD, and DU are non-limiting examples of the SBFD configurations and corresponding parameters. One or more of these configurations may be included though it is well-understood that other configurations may be included also.

Modes of operation based on association of power ramping sets and configured ROs are described herein. A WTRU may select an RO for PRACH preamble transmission out of the configured available and valid (N) ROs, in association with the selected SSB. The WTRU may determine the set of power ramping configurations based on the selected RO's location in the frequency domain out of the configured (M) FDM-ed ROs and the configured subset of (P) ROs. The WTRU may transmit the PRACH preamble based on the calculated first PRACH power based on the initiated power ramping counter.

In some examples, after transmission of PRACH preamble based on the first PRACH power, if a RAR is not received within a configured RAR reception window, the WTRU may increment the power ramping counter and if the counter has not reached the MAX value, the WTRU may calculate a second PRACH power based on the determined set of power ramping configurations. The WTRU may retransmit the PRACH preamble and apply the second PRACH power. In some examples, the WTRU may use the same set of determined power ramping configurations for all retransmissions.

In some solutions, a WTRU may determine a mode of operation based on the selected RO's location in the frequency domain with regards to the configured (M) FDM-ed ROs, the determined set of power ramping configurations, the configured (M) FDM-ed ROs, and indicated subset of (P) ROs. One or more modes of operation may be applied as follows.

A first mode of operation may entail the use of a first set of power ramping configurations. For example, in case the selected RO (out of the configured N ROs) is within the configured subset of (P) ROs, the WTRU may determine to use the first set of power ramping configurations. That is, in an example, a WTRU that has transmitted a PRACH preamble based on a power ramping counter and a first PRACH power and has not received RAR within the configured RAR window may increment the power ramping counter. In case the counter has not reached a first configured maximum value (e.g., maximum number of Random-Access Preamble transmission, e.g., TransMax), the WTRU may calculate a second PRACH power based on the power ramping counter and the first configured power ramping step. The WTRU may transmit the PRACH preamble in the selected RO based on the second PRACH power.

A second mode of operation may entail the use of a second set of power ramping configurations. For example, in case the selected RO (out of the configured N ROs) is not within the configured subset of (P) ROs, the WTRU may determine to use the second set of power ramping configurations. That is, in some examples, the WTRU that has transmitted a PRACH preamble based on a power ramping counter and a first PRACH power and has not received a RAR within the configured RAR window, may increment the power ramping counter. In case the counter has not reached the second configured maximum value (e.g., maximum number of Random-Access Preamble transmission, e.g., TransMax), the WTRU may calculate a second PRACH power based on the power ramping counter and the second configured power ramping step. The WTRU may transmit the PRACH preamble in the selected RO based on the second PRACH power.

A third mode of operation may entail switching from second set of power ramping configurations to the first set of power ramping configurations. For example, a WTRU that is using the second set of power ramping configurations for performing power ramping in random access procedure, for example for calculating the PRACH power, may determine that the power ramping counter has reached to the configured second maximum value (e.g., maximum number of Random-Access Preamble transmission, e.g., TransMax). In case the WTRU does not receive RAR within the configured RAR reception window, the WTRU may determine to increase the PRACH power. As such, the WTRU may switch to use another available and valid configured RO (out of the N configured ROs) that is within the configured subset of (P) ROs, out of the M FDM-ed ROs, in order to use the configured first set of power ramping configurations.

A fourth mode of operation may entail fall back to non-SBFD ROs. For example, a WTRU in a third mode of operation may fallback to performing a random-access procedure based on non-SBFD ROs in case there are no valid or available ROs configured (out of the configured N ROs) that are within the configured subset of (P) ROs. That is, in an example, the WTRU may not be configured with any ROs (out of the configured NROs) that are within the configured subset of (P) ROs. In another example, the WTRU may be restricted via one or more indications (e.g., SSB Mask Index) to only use a subset (K) of ROs, where none of the allowed (K) ROs may be within the configured subset of (P) ROs.

The WTRU may use the determined set of configured power ramping configurations to calculate the PRACH power. The WTRU may transmit PRACH preamble based on the selected RO and calculated PRACH power.

Methods for switching between power ramping configurations in SBFD systems is described herein. In some examples, a WTRU that may be operating in a third mode of operation as described above may determine to switch from using the second configured set of power ramping configurations based on a first power ramping counter to the first configured set of power ramping configurations. In some examples, the WTRU may initialize a second power ramping counter to a (pre) configured initial value (e.g., value of one). In some examples, the WTRU may calculate the second power ramping counter based on the first power ramping counter in addition to the first and second configured power ramping steps.

In some examples, the WTRU may set the second power ramping counter as shown in Equation 2:

$$⌈ \frac{1 st power ramping step}{2 nd power ramping step} \times ( 1 st power ramping counter ) ⌉ \qquad Eq . 2$$

The WTRU may use the calculated second power ramping counter to calculate the PRACH power and to transmit the PRACH preamble in the selected RO.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU), the WTRU comprising:
a processor; and
a transceiver;
the processor and the transceiver configured to receive system information indicating a random access channel (RACH) configuration, wherein the RACH configuration includes an indication of a plurality of RACH occasions, wherein the RACH configuration indicates a plurality of synchronization signal blocks (SSBs) are each associated with a respective subset of the plurality of RACH occasions, and wherein RACH occasions within each respective subset are frequency division multiplexed;
the processor and the transceiver configured to receive configuration information indicating at least one transmit power threshold;
the processor and the transceiver configured to receive information indicating resources associated with a subband non-overlapping full duplex (SBFD) mode of operation, the indicated resources including at least one uplink SBFD subband and at least one downlink SBFD subband;
the processor and the transceiver configured to receive criteria for selecting a RACH occasion in which to send a preamble transmission, the criteria defining a group of the plurality of RACH occasions that overlap with the at least one uplink SBFD subband;
the processor and the transceiver configured to measure at least one reference signal received power (RSRP) associated with at least one SSB;
the processor and the transceiver configured to select one of the plurality of SSBs based on the measured at least one RSRP and to calculate, based on the measured at least one RSRP, a transmit power with which to send the preamble transmission; and
the processor and the transceiver configured to send the preamble transmission using the calculated transmit power in a selected RACH occasion from a respective subset of the configured plurality of RACH occasions associated with the selected SSB, wherein, on a condition the calculated transmit power exceeds the configured transmit power threshold, the selected RACH occasion is selected from the defined group of the plurality of RACH occasions.

2. The WTRU of claim 1, the processor and the transceiver configured to receive configuration information indicating a plurality of transmit power thresholds.

3. The WTRU of claim 2, wherein the criteria for selecting a RACH occasion in which to send a preamble transmission defines a plurality of groups of the plurality of RACH occasions that overlap with the at least one uplink SFBD subband.

4. The WTRU of claim 3, wherein the selected RACH occasion is selected from one of the defined groups of the plurality of RACH occasions that overlap with the at least one uplink SBFD subband based on whether the calculated transmit power exceeds a corresponding one of the plurality of transmit power thresholds.

5. The WTRU of claim 3, wherein each of the defined plurality of groups of the plurality of RACH occasions include a different number of RACH occasions.

6. The WTRU of claim 1, wherein the defined group of the plurality of RACH occasions include consecutive RACH occasions in the frequency domain.

7. The WTRU of claim 1, wherein the defined group of the plurality of RACH occasions are of a plurality of respective subsets of RACH occasions each associated with different SSBs.

8. The WTRU of claim 1, wherein RACH occasions associated with at least two SSBs are frequency division multiplexed.

9. A method performed by a wireless transmit/receive unit (WTRU), the method comprising:
receiving system information indicating a random access channel (RACH) configuration, wherein the RACH configuration includes an indication of a plurality of RACH occasions, wherein the RACH configuration indicates a plurality of synchronization signal blocks (SSBs) are each associated with a respective subset of the plurality of RACH occasions, and wherein RACH occasions within each respective subset are frequency division multiplexed;
receiving configuration information indicating at least one transmit power threshold;
receiving system information indicating resources associated with a subband non-overlapping full duplex (SBFD) mode of operation, the indicated resources including at least one uplink SBFD subband and at least one downlink SBFD subband;
receiving criteria for selecting a RACH occasion in which to send a preamble transmission, the criteria defining a group of the plurality of RACH occasions that overlap with the at least one uplink SBFD subband;
measure at least one reference signal received power (RSRP) associated with at least one SSB;
selecting one of the plurality of SSBs based on the measured at least one RSRP and to calculate, based on the measured RSRP, a transmit power with which to send the preamble transmission; and
sending the preamble transmission using the calculated transmit power in a selected RACH occasion from a respective subset of the configured plurality of RACH occasions associated with the selected SSB, wherein, on a condition the calculated transmit power exceeds the configured transmit power threshold, the selected RACH occasion is selected from the defined group of the plurality of RACH occasions.

10. The method of claim 9 comprising receiving configuration information indicating a plurality of transmit power thresholds.

11. The method of claim 10, wherein the criteria for selecting a RACH occasion in which to send a preamble transmission defines a plurality of groups of the plurality of RACH occasions that overlap with the at least one uplink SBFD subband.

12. The method of claim 11, wherein the selected RACH occasion is selected from one of the defined groups of the plurality of RACH occasions that overlap with the at least one uplink SBFD subband based on whether the calculated transmit power exceeds a corresponding one of the plurality of transmit power thresholds.

13. The method of claim 11, wherein each of the defined plurality of groups of the plurality of RACH occasions include a different number of RACH occasions.

14. The method of claim 9, wherein the defined group of the plurality of RACH occasions include consecutive RACH occasions in the frequency domain.

15. The method of claim 9, wherein the defined group of the plurality of RACH occasions are of a plurality of respective subsets of RACH occasions each associated with different SSBs.

16. The method of claim 9, wherein RACH occasions associated with at least two SSBs are frequency division multiplexed.
